(19) United States
(12) Patent Application Publication
(10) Pub. No.: US 2018/0127621 A1
(43) Pub. Date: May 10, 2018

(54) ADHESIVE FILM AND PROCESS FOR PRODUCING THE SAME

(71) Applicant: MITSUBISHI CHEMICAL CORPORATION, Tokyo (JP)

(72) Inventor: Taishi KAWASAKI, Maibara-shi (JP)

(21) Appl. No.: 15/861,778

(22) Filed: Jan. 4, 2018

Related U.S. Application Data
(62) Division of application No. 15/320,897, filed on Dec. 21, 2016.

(30) Foreign Application Priority Data
Mar. 5, 2016 (JP) 2016-042898
Mar. 5, 2016 (JP) 2016-042899

(51) Int. Cl. C09J 133/10; C09J 9/00; C09J 5/00

(52) U.S. Cl. CPC C09J 7/385; C09J 133/10; C09J 2467/006; C09J 5/00; C09J 2433/00; C09J 9/00

(57) ABSTRACT

The present invention provides an adhesive film hardly suffering from fisheyes and having excellent mechanical strength and heat resistance as well as good adhesion properties, which can be suitably used as various surface protective films, etc. The present invention relates to an adhesive film comprising a polyester film and an adhesive layer formed on at least one surface of the polyester film, in which the adhesive layer comprises a (meth)acrylic resin comprising a (meth)acrylate unit that comprises an alkyl group having not less than 4 carbon atoms at an ester end thereof, a content of the (meth)acrylate unit in the (meth)acrylic resin being not less than 20% by weight; and an adhesion strength to a polymethyl methacrylate plate of the adhesive layer is not less than 1 mN/cm.

This application is a divisional of U.S. application Ser. No. 15/320,897 filed Dec. 21, 2016, which is the U.S. national phase of International Appln. No. PCT/JP2016/061810 filed Apr. 12, 2016, which designated the U.S. and claims priority to JP Appln. Nos. 2016-042898 and 2016-042899 both filed Mar. 5, 2016, the entire contents of each of which are hereby incorporated by reference.

### TECHNICAL FIELD

The present invention relates to an adhesive film and a process for producing the adhesive film, and more particularly, to an adhesive film hardly suffering from fisheyes and having excellent mechanical strength and heat resistance as well as good adhesion properties, which can be suitably used as a surface protective film, etc., for example, for preventing formation of scratches or deposition of contaminants on resin plates, metal plates, etc., upon transportation, storage or processing thereof, and a process for producing the adhesive film.

### BACKGROUND ART

Hitherto, surface protective films have been extensively used in the applications for preventing formation of scratches or deposition of contaminants on resin plates, metal plates, glass plates, etc., upon transportation, storage or processing thereof, preventing formation of scratches or deposition of dirt and dusts or contaminants on members used in electronics-related fields such as liquid crystal display panels and polarizing plates upon processing thereof, preventing deposition of contaminants on automobiles upon transportation or storage thereof or protecting automobile painting against acid rain, protecting flexible printed boards upon plating or etching treatments thereof, and the like.

It has been required that these surface protective films can exhibit an adequate adhesion strength to various kinds of adherends such as resin plates, metal plates and glass plates upon transportation, storage or processing thereof, can be attached onto these adherends to protect the surface thereof, and can be easily peeled off from the adherends after accomplishing the objects as aimed. In order to overcome these problems or tasks, the use of polyolefin-based films for the purpose of protecting the surface of the adherends has been proposed (Patent Literatures 1 and 2).

However, since the polyolefin-based films are used as a base material of the surface protective films, it is not possible to avoid occurrence of defects generally called fisheyes, i.e., formation of gels or deteriorated products derived from raw materials of the base material of the film. For example, there tends to arise such a problem that when testing or inspecting the adherend onto which the surface protective film is kept attached, these defects on the surface protective film are detected as defects of the adherend, etc., thereby causing disturbance of the test or inspection.

In addition, the base material for the surface protective films is required to have a certain degree of mechanical strength to such an extent that the base material is free of expansion owing to a tensile force applied upon various processing steps such as lamination onto the adherend, etc. However, the polyolefin-based films are generally deteriorated in mechanical strength, so that there tends to occur such a problem that the films are unsuitable for high-tension processing steps in association with increase in film-processing velocity, etc., which must be conducted in view of the importance to productivity of the film.

Further, in the case where the processing temperature of the polyolefin-based films is increased for enhancing processing velocity or improving various properties thereof, the polyolefin-based films tend to suffer from deterioration in dimensional stability owing to poor shrink stability upon heating the films. For this reason, there is an increasing demand for films having not only less heat deformation but also excellent dimensional stability even when subjected to high-temperature processing steps.

### CITATION LIST

### Patent Literatures

Patent Literature 1: Japanese Patent Application Laid-Open (KOKAI) No. 5-98219

Patent Literature 2: Japanese Patent Application Laid-Open (KOKAI) No. 2007-270005

### SUMMARY OF INVENTION

### Technical Problem

The present invention has been attained to solve the above conventional problems. An object of the present invention is to provide an adhesive film hardly suffering from fisheyes and having excellent mechanical strength and heat resistance as well as good adhesion properties, which can be suitably used as various surface protective films, etc., and a process for producing the adhesive film.

### Solution to Problem

As a result of the present inventors' earnest study in view of the above conventional problems, it has been found that these problems can be readily solved by using an adhesive film having a specific structure. The present invention has been attained on the basis of this finding.

That is, in a first aspect of the present invention, there is provided an adhesive film comprising a polyester film and an adhesive layer formed on at least one surface of the polyester film, the adhesive layer comprising a (meth)acrylic resin comprising a (meth)acrylate unit that comprises an alkyl group having not less than 4 carbon atoms at an ester end thereof, a content of the (meth)acrylate unit in the (meth)acrylic resin being not less than 20% by weight; and an adhesion strength to a polymethyl methacrylate plate of the adhesive layer being not less than 1 mN/cm. Further, in a second aspect of the present invention, there is provided a process for producing an adhesive film, comprising the steps of:

providing a coating layer on at least one surface of a polyester film, the coating layer comprising a (meth)acrylic resin comprising a (meth)acrylate unit that comprises an alkyl group having not less than 4 carbon atoms at an ester end thereof, a content of the (meth)acrylate unit in the (meth)acrylic resin being not less than 20% by weight; and

drawing the polyester film provided with the coating layer in at least one direction thereof.

### Advantageous Effects of Invention

In accordance with the present invention, it is possible to provide an adhesive film hardly suffering from fisheyes and having excellent mechanical strength and heat resistance as well as good adhesion properties, which can be suitably used as various surface protective films. Therefore, the present invention has a high industrial value.

### DESCRIPTION OF EMBODIMENTS

In order to achieve the above objects, i.e., reduction of formation of fisheyes in the film and improvement in mechanical strength and heat resistance of the film, it has been considered to be necessary that a fundamental material of the base film is drastically changed to other materials. As a result of various studies conducted based on the aforementioned consideration, it has been found that the aforementioned objects can be achieved by using a polyester-based material that is considerably different from the conventionally used polyolefin-based materials. However, when the material of the base film is largely changed as described above, the resulting film tends to be deteriorated in adhesion properties to a large extent. Thus, general polyester films have failed to attain satisfactory results. In consequence, it has been contemplated to improve properties of the film by providing an adhesive layer on the base film. As a result, the present invention has been attained based on the improvement.

The polyester film constituting the adhesive film may have either a single layer structure or a multilayer structure. Unless departing from the scope of the present invention, the polyester film may have not only a two or three layer structure but also a four or more multilayer structure, and the layer structure of the polyester film is not particularly limited. The polyester film preferably has a two or more multilayer structure to impart specific characteristics to the respective layers and thereby contemplate provision of a multi-functionalized film.

The polyester used in the present invention may be in the form of either a homopolyester or a copolyester. The homopolyester is preferably obtained by polycondensing an aromatic dicarboxylic acid and an aliphatic glycol. Examples of the aromatic dicarboxylic acid include terephthalic acid and 2,6-naphthalenedicarboxylic acid. Examples of the aliphatic glycol include ethylene glycol, diethylene glycol and 1,4-cyclohexanedimethanol. Typical examples of the polyesters include polyethylene terephthalate or the like. On the other hand, as a dicarboxylic acid component of the copolyester, there may be mentioned at least one compound selected from the group consisting of isophthalic acid, phthalic acid, terephthalic acid, 2,6-naphthalenedicarboxylic acid, adipic acid, sebacic acid and oxycarboxylic acids (such as, for example, p-oxybenzoic acid). As a glycol component of the copolyester, there may be mentioned at least one compound selected from the group consisting of ethylene glycol, diethylene glycol, propylene glycol, butanediol, 4-cyclohexanedimethanol and neopentyl glycol.

From the standpoint of producing a film capable of withstanding various processing conditions, the polyester film is preferably enhanced in mechanical strength and heat resistance (dimensional stability upon heating). To this end, it may be preferred that the polyester film comprises a less amount of a copolyester component. More specifically, the content of monomers forming the copolyester in the polyester film is usually in the range of not more than 10 mol %, preferably not more than 5 mol %, and more preferably not more than 3 mol % which may be the same extent as a content of a diether component produced as a by-product upon polymerization for production of a homopolyester. The configuration of the polyester is preferably a film formed of polyethylene terephthalate prepared by polymerizing terephthalic acid and ethylene glycol among the aforementioned compounds, or polyethylene naphthalate, in view of good mechanical strength and heat resistance of the film, and more preferably a film formed of polyethylene terephthalate in view of facilitated production of the film and good handling properties of the film when used in the applications such as a surface protective film.

The polymerization catalyst for production of the polyester is not particularly limited, and any conventionally known compounds may be used as the polymerization catalyst. Examples of the polymerization catalyst include an antimony compound, a titanium compound, a germanium compound, a manganese compound, an aluminum compound, a magnesium compound and a calcium compound. Of these compounds, the antimony compound is preferred in view of inexpensiveness. In addition, the titanium compound or the germanium compound is also preferably used because they exhibit a high catalytic activity, and are capable of conducting the polymerization even when used in a small amount, and enhancing transparency of the obtained film owing to a less amount of the metals remaining in the film. Further, the use of the titanium compound is more preferred because the germanium compound is expensive.

When using the titanium compound upon production of the polyester, the content of the titanium element in the polyester is usually in the range of not more than 50 ppm, preferably 1 to 20 ppm, and more preferably 2 to 10 ppm. When the content of the titanium element in the polyester is excessively large, the polyester tends to suffer from accelerated deterioration in the step of melt-extruding the polyester so that the resulting film tends to exhibit a strong yellowish color. On the other hand, when the content of the titanium element in the polyester is excessively small, the polymerization efficiency tends to be deteriorated, so that the cost tends to be increased, and the resulting film tends to hardly exhibit a sufficient strength. In addition, when using the titanium compound upon production of the polyester, for the purpose of suppressing deterioration thereof in the melt-extrusion step, a phosphorus compound is preferably used to reduce an activity of the titanium compound. As the phosphorus compound, orthophosphoric acid is preferably used in view of productivity and thermal stability of the obtained polyester. The content of the phosphorus element in the polyester is usually in the range of 1 to 300 ppm, preferably 3 to 200 ppm, and more preferably 5 to 100 ppm based on the amount of the polyester melt-extruded. When the content of the phosphorus compound in the polyester is excessively large, gelation of the polyester or inclusion of foreign matters therein tends to be caused. On the other hand, when the content of the phosphorus compound in the polyester is excessively small, it is not possible to sufficiently reduce an activity of the titanium compound, so that the resulting film tends to exhibit a yellowish color.

For the purpose of imparting easy-slipping properties to the resulting film, preventing occurrence of flaws on the film in the respective steps and improving anti-blocking properties of the film, the polyester layer may also comprise particles. When the particles are compounded in the film, the kinds of particles compounded in the film are not particularly limited as long as they are capable of imparting easy-slipping properties to the resulting film. Specific examples of the particles include inorganic particles such as particles of silica, calcium carbonate, magnesium carbonate, barium carbonate, calcium sulfate, calcium phosphate, magnesium phosphate, kaolin, aluminum oxide, zirconium oxide and titanium oxide; and organic particles such as particles of acrylic resins, styrene resins, urea resins, phenol resins, epoxy resins and benzoguanamine resins. Further, there may also be used deposited particles obtained by precipitating and finely dispersing a part of metal compounds such as a catalyst during the process for production of the polyester. Of these particles, in particular, from the standpoint of exhibiting good effects even when used in a small amount, silica particles and calcium carbonate particles are preferably used.

The average particle diameter of the particles incorporated into the film is usually in the range of not more than 10 μm, preferably 0.01 to 5 μm, and more preferably 0.01 to 3 μm. When the average particle diameter of the particles is more than 10 μm, there tends occur such a fear that the obtained film suffers from defects owing to deteriorated transparency.

Further, the content of the particles in the polyester layer may vary depending upon the average particle diameter of the particles, and is therefore not particularly limited. The content of the particles in the polyester layer of the film is usually in the range of not more than 5% by weight, preferably 0.0003 to 3% by weight, and more preferably 0.0005 to 1% by weight. When the content of the particles in the polyester layer of the film is more than 5% by weight, there tends to occur such a fear that the obtained film suffers from defects owing to falling off of the particles and deteriorated transparency, etc. When no particles or merely a less amount of the particles are used in the film, there tend to occur problems such as insufficient slipping properties of the resulting film, so that it is necessary to take any measures for enhancing the slipping properties, such as incorporation of particles into the adhesive layer, or the like.

The shape of the particles used in the polyester layer of the film is also not particularly limited, and may be any of a spherical shape, a massive shape, a bar shape, a flat shape, etc. Further, the hardness, specific gravity, color and the like of the particles are also not particularly limited. These particles may be used in combination of any two or more kinds thereof, if required.

The method of adding the particles to the polyester layer is not particularly limited, and any conventionally known methods can be suitably used for adding the particles to the polyester layer. For example, the particles may be added at any optional stages in the process for producing the polyester forming the respective layers. The particles are preferably added to the polyester after completion of the esterification reaction or transesterification reaction.

The polyester film used in the present invention may also comprise, in addition to the above particles, conventionally known additives such as an ultraviolet absorber, an antioxidant, an antistatic agent, a thermal stabilizer, a lubricant, a dye, a pigment, etc., if required.

The thickness of the polyester film used in the present invention is not particularly limited, and the film may have any thickness as long as any suitable film can be formed. The thickness of the film is usually in the range of 2 to 350 μm, preferably 5 to 200 μm and more preferably 8 to 75 μm.

An example of the process for production of the film is specifically described below. However, the present invention is not particularly limited to the below-mentioned production process, and a conventionally known film-forming method may also be used in the present invention.

In general, the film may be produced by melting a resin, forming the molten resin into a sheet, and then subjecting the resulting sheet to drawing for the purpose of enhancing strength thereof, etc.

For example, in the case of producing a biaxially oriented polyester film, there may be used the following method.

First, a raw polyester material is melted and extruded from a die using an extruder in the form of a molten sheet, and the molten sheet is cooled and solidified on a chilled roll to obtain an undrawn sheet. In this case, in order to enhance flatness of the obtained sheet, it is preferred to enhance adhesion between the sheet and the rotary chilled drum. For this purpose, an electrostatic pinning method or a liquid coating adhesion method is preferably used.

Next, the thus obtained undrawn sheet is drawn in one direction thereof using a roll-type or tenter-type drawing machine. The drawing temperature is usually 70 to 120° C. and preferably 80 to 110° C., and the draw ratio is usually 2.5 to 7 times and preferably 3.0 to 6 times.

Then, the thus drawn sheet is further drawn in the direction perpendicular to the direction of drawing in the first-stage drawing step. In this case, the drawing temperature is usually 70 to 170° C., and the draw ratio is usually 2.5 to 7 times and preferably 3.0 to 6 times.

Subsequently, the resulting biaxially drawn sheet is subjected to heat-setting treatment at a temperature of 180 to 270° C. under tension or under relaxation within 30% to obtain a biaxially oriented film.

Upon the above drawing steps, there may also be used the method in which the drawing in each direction is carried out in two or more stages. In such a case, the multi-stage drawing is preferably performed such that the total draw ratio in each of the two directions finally falls within the aforementioned specific range.

Also, upon producing the polyester film constituting the adhesive film, there may also be used a simultaneous biaxial drawing method. The simultaneous biaxial drawing method is such a method in which the aforementioned undrawn sheet is drawn and oriented in both of the machine and width directions at the same time while maintaining the sheet in a suitably temperature-controlled condition in which the sheet is controlled to a temperature of usually 70 to 120° C. and preferably 80 to 110° C. The draw ratio used in the simultaneous biaxial drawing method is usually 4 to 50 times, preferably 7 to 35 times and more preferably 10 to 25 times in terms of an area ratio of the sheet to be drawn. Successively, the obtained biaxially drawn sheet is subjected to heat-setting treatment at a temperature of usually 180 to 270° C. under tension or under relaxation within 30% to obtain a drawn oriented film. As the apparatus used in the above simultaneous biaxial drawing method, there may be employed any conventionally known drawing apparatuses such as a screw type drawing apparatus, a pantograph type drawing apparatus and a linear drive type drawing apparatus, etc.

Next, the method of forming the adhesive layer constituting the adhesive film is described. As the method of forming the adhesive layer, there may be mentioned, for example, a coating method, a transfer method, a lamination method, etc. In view of facilitated formation of the adhesive layer, of these methods, preferred is the coating method.

When using the coating method, the adhesive layer may be formed by either an in-line coating method in which the coating is carried out during the step of producing the film, or an off-line coating method in which the film produced is once taken outside of the film production system and subjected to the coating treatment. Of these coating methods, preferred is the in-line coating method.

More specifically, in the in-line coating method, the coating step is carried out in an optional stage during the period from the step of melt-extruding the resin forming the film up to the step of taking-up the resulting film via the step of subjecting the melt-extruded resin to drawing and then heat-setting. In the in-line coating method, any of the undrawn sheet obtained by the melting and rapid cooling, the monoaxially drawn film, the biaxially oriented film before the heat-setting, and the film after the heat-setting but before the taking-up, is usually subjected to the coating step. For example, in the case of a sequential biaxial drawing process, there may be used such an excellent method in which after subjecting the monoaxially drawn film that is drawn in a length direction (longitudinal direction) of the film to the coating step, the thus coated monoaxially drawn film is drawn in a lateral direction thereof, though the present invention is not particularly limited thereto. The aforementioned in-line coating method is also advantageous from the standpoint of production cost, because the film is formed simultaneously with formation of the adhesive layer thereon. Also, since the drawing is conducted after the coating step, the thickness of the adhesive layer may be changed by adjusting a draw ratio of the film, so that the thin-film coating step can be more easily conducted as compared to the off-line coating method.

In addition, in the aforementioned in-line coating method, by providing the adhesive layer on the film before the drawing step, it is possible to subject the adhesive layer together with the base film to the drawing step, so that the adhesive layer can be strongly adhered to the base film. Further, upon production of the biaxially oriented polyester film, since the film is drawn while grasping end portions of the film by clips, etc., it is possible to constrain the film in both of the longitudinal and lateral directions. As a result, in the heat-setting step, it is possible to expose the film to high temperature without formation of wrinkles, etc., while maintaining flatness of the film.

For this reason, in the aforementioned in-line coating method, the heat-setting treatment after the coating step can be conducted at a high temperature that is not achievable by the other methods, so that it is possible to enhance film-forming properties of the adhesive layer, strongly adhere the adhesive layer to the base film, and further strengthen the resulting adhesive layer. In particular, the aforementioned method is very effective in the reaction with a crosslinking agent.

According to the process conducted by the aforementioned in-line coating method, no large change in dimension of the film is caused depending on whether or not the adhesive layer is formed thereon, and no large risk of formation of flaws or deposition of foreign matters on the film is also caused depending on whether or not the adhesive layer is formed thereon. Therefore, the in-line coating method is considerably advantageous as compared to the off-line coating method in which it is necessary to conduct the coating step as an additional surplus step. Furthermore, as a result of various studies, it has been found that the in-line coating method is also advantageous in such a point that the in-line coating method is capable of more effectively reducing adhesive residue as components of the adhesive layer transferred to an adherend when allowing the film of the present invention to adhere to the adherend. This is because the in-line coating method is capable of conducting the heat-setting treatment at a much higher temperature that is not achievable by the off-line coating method. It is considered that the aforementioned advantage of the in-line coating method is the result obtained from the stronger adhesion between the adhesive layer and the base film as achieved in the adhesive film of the present invention.

In the present invention, it is essentially required that the adhesive film comprises an adhesive layer comprising a (meth)acrylic resin comprising a (meth)acrylate unit that comprises an alkyl group having not less than 4 carbon atoms at an ester end thereof, in which a content of the (meth)acrylate unit in the (meth)acrylic resin is not less than 20% by weight, and an adhesion strength to a polymethyl methacrylate plate of the adhesive layer is not less than 1 mN/cm.

The (meth)acrylic resin comprising a (meth)acrylate unit that comprises an alkyl group having not less than 4 carbon atoms at an ester end thereof as used in the present invention is a polymer produced from a polymerizable monomer including an acrylic monomer and a methacrylic monomer (“acrylic” and “methacrylic” are hereinafter collectively referred to merely as “(meth)acrylic”), and the content of the (meth)acrylate unit that comprises an alkyl group having not less than 4 carbon atoms at an ester end thereof in the (meth)acrylic resin as a whole is not less than 20% by weight. These (meth)acrylic resins may be in the form of either a homopolymer or a copolymer, as well as may be in the form of a copolymer with a polymerizable monomer other than the acrylic and methacrylic monomers.

The polymer may also include a copolymer of any of the aforementioned polymers with the other polymer (such as, for example, a polyester and a polyurethane). Examples of such a copolymer include a block copolymer and a graft copolymer. In addition, the polymer may also include a polymer obtained by polymerizing the polymerizable monomer in a polyester solution or a polyester dispersion (which may also be in the form of a mixture of the polymers). Furthermore, the polymer may also include a polymer obtained by polymerizing the polymerizable monomer in a polyurethane solution or a polyurethane dispersion (which may also be in the form of a mixture of the polymers). Similarly, the polymer may also include a polymer obtained by polymerizing the polymerizable monomer in the other polymer solution or the other polymer dispersion (which may also be in the form of a mixture of the polymers). However, in view of good adhesion properties and less adhesive residue on an adherend, it is preferred that the (meth)acrylic resin contains no other polymer such as polyesters and polyurethanes (i.e., the (meth)acrylic resin is a (meth)acrylic resin constituted of only the polymerizable monomer having a carbon-carbon double bond (which may be in the form of either a homopolymer or a copolymer)).

As the (meth)acrylate unit that comprises an alkyl group having not less than 4 carbon atoms at an ester end thereof, there may be used conventionally known (meth)acrylates. Of these (meth)acrylates, particularly preferred are (meth)acrylates whose homopolymer has a glass transition point of not higher than 0° C. Examples of the (meth)acrylates whose homopolymer has a glass transition point of not higher than 0° C. include n-butyl acrylate (glass transition point: −55° C. (which means a glass transition point of a homopolymer thereof; hereinafter defined in the same way)), n-hexyl acrylate (glass transition point: −57° C.), 2-ethylhexyl acrylate (glass transition point: −70° C.), n-octyl acrylate (glass transition point: −65° C.), isooctyl acrylate (glass transition point: −83° C.), n-nonyl acrylate (glass transition point: −63° C.), n-nonyl methacrylate (glass transition point: −35° C.), isononyl acrylate (glass transition point: −82° C.), n-decyl acrylate (glass transition point: −70° C.), n-decyl methacrylate (glass transition point: −45° C.), isodecyl acrylate (glass transition point: −55° C.), isodecyl methacrylate (glass transition point: −41° C.), lauryl acrylate (glass transition point: −30° C.), lauryl methacrylate (glass transition point: −65° C.), tridecyl acrylate (glass transition point: −75° C.), tridecyl methacrylate (glass transition point: −46° C.), isomyristyl acrylate (glass transition point: −56° C.), etc.

Among the aforementioned (meth)acrylates, for the purpose of improving adhesion properties of the resulting film, alkyl (meth)acrylates comprising an alkyl group usually having 4 to 30 carbon atoms, preferably 4 to 20 carbon atoms and more preferably 4 to 14 carbon atoms can be suitably used. From the standpoint of high industrial mass productivity as well as good handling properties and good supply stability, (meth)acrylic resins comprising n-butyl acrylate or 2-ethylhexyl acrylate as a constituent thereof are optimum.

It is essentially required that the content of the (meth)acrylate unit that comprises an alkyl group having not less than 4 carbon atoms at an ester end thereof in the (meth)acrylic resin is in the range of not less than 20% by weight. The content of the (meth)acrylate unit that comprises an alkyl group having not less than 4 carbon atoms at an ester end thereof in the (meth)acrylic resin is preferably in the range of 35 to 99% by weight, more preferably 50 to 98% by weight, even more preferably 65 to 95% by weight and most preferably 75 to 90% by weight. When the content of the (meth)acrylate unit that comprises an alkyl group having not less than 4 carbon atoms at an ester end thereof in the (meth)acrylic resin is increased, the adhesion properties of the resulting film become higher. On the contrary, when the content of the (meth)acrylate unit that comprises an alkyl group having not less than 4 carbon atoms at an ester end thereof in the (meth)acrylic resin is excessively small, the resulting film tends to be insufficient in adhesion strength.

As the components other than the (meth)acrylate unit that comprises an alkyl group having not less than 4 carbon atoms at an ester end thereof which may be included in the (meth)acrylic resin, there may be used conventionally known polymerizable monomers. The polymerizable monomers are not particularly limited. Examples of the typical compounds of the polymerizable monomers include various carboxyl group-containing monomers such as acrylic acid, methacrylic acid, crotonic acid, itaconic acid, fumaric acid, maleic acid and citraconic acid, and salts thereof; various hydroxyl group-containing monomers such as 2-hydroxyethyl (meth)acrylate and 2-hydroxypropyl (meth)acrylate; various (meth)acrylic acid esters such as methyl (meth)acrylate, ethyl (meth)acrylate and propyl (meth)acrylate; various nitrogen-containing compounds such as (meth)acrylamide, diacetone acrylamide, N-methylol acrylamide and (meth)acrylonitrile; various styrene derivatives such as styrene, □-methyl styrene, divinyl benzene and vinyl toluene; various vinyl esters such as vinyl propionate and vinyl acetate; various silicon-containing polymerizable monomers such as □-methacryloxypropyl trimethoxysilane and vinyl trimethoxysilane; various phosphorus-containing vinyl-based monomers; various vinyl halides such as vinyl chloride and vinylidene chloride; and various conjugated dienes such as butadiene.

Among the aforementioned compounds, for the purpose of improving adhesion properties of the resulting film, preferred are (meth)acrylates whose homopolymer has a glass transition point of not higher than 0° C. Examples of the preferred (meth)acrylates include (meth)acrylates comprising an alkyl group having less than 4 carbon atoms at an ester end thereof, such as ethyl acrylate (glass transition point: −22° C.), n-propyl acrylate (glass transition point: −37° C.) and isopropyl acrylate (glass transition point: −5° C.). Among these (meth)acrylates, ethyl acrylate is more preferred from the standpoint of good handling properties thereof.

The content of a (meth)acrylate unit comprising an alkyl group having less than 4 carbon atoms at an ester end thereof whose homopolymer has a glass transition point of not higher than 0° C. in the (meth)acrylic resin is preferably in the range of not more than 50% by weight, more preferably not more than 40% by weight and even more preferably not more than 30% by weight. When controlling the content of the (meth)acrylate unit comprising an alkyl group having less than 4 carbon atoms at an ester end thereof in the (meth)acrylic resin to the aforementioned specific range, the resulting film can exhibit good adhesion properties.

Also, from the standpoint of reducing transfer of the adhesive component to an adherend, among the aforementioned compounds, preferred is the compound having not more than 2 carbon atoms at an ester end thereof or the compound having a ring structure, and more preferred is the compound having 1 carbon atom at an ester end thereof or an aromatic compound. Specific examples of the preferred compounds include methyl methacrylate, acrylonitrile, styrene and cyclohexyl acrylate.

The content of a constitutional unit derived from the compound unit having not more than 2 carbon atoms at an ester end thereof in the (meth)acrylic resin is preferably in the range of not more than 50% by weight, more preferably 1 to 40% by weight, even more preferably 3 to 30% by weight and most preferably 5 to 20% by weight. When the content of the aforementioned constitutional unit in the (meth)acrylic resin is reduced, the resulting film is free of considerable deterioration in adhesion properties thereof so that adhesion properties in an adequate range can be imparted to the film. On the contrary, when the content of the aforementioned constitutional unit in the (meth)acrylic resin is increased, it is possible to reduce transfer of the adhesive component to an adherend. For these reasons, when the content of the aforementioned constitutional unit in the (meth)acrylic resin falls within the aforementioned specific range, the two objects including good adhesion properties of the film and reduced transfer of the adhesive component to an adherend are more likely to be achieved.

The content of the compound unit having a ring structure in the (meth)acrylic resin is preferably in the range of not more than 50% by weight, more preferably 1 to 45% by weight and even more preferably 5 to 40% by weight. When the content of the compound unit having a ring structure in the (meth)acrylic resin is reduced, the resulting film is free of considerable deterioration in adhesion properties thereof so that adhesion properties in an adequate range can be imparted to the film. On the contrary, when the content of the compound unit having a ring structure in the (meth)acrylic resin is increased, it is possible to reduce transfer of the adhesive component to an adherend. For these reasons, when the content of the compound unit having a ring structure in the (meth)acrylic resin falls within the aforementioned specific range, the two objects including good adhesion properties of the film and reduced transfer of the adhesive component to an adherend are more likely to be achieved.

From the standpoint of attaining good adhesion properties of the resulting film, the content of the monomer whose homopolymer has a glass transition point of not higher than 0° C., as a monomer constituting the (meth)acrylic resin, is preferably in the range of not less than 30% by weight, more preferably not less than 45% by weight, even more preferably not less than 60% by weight and most preferably not less than 70% by weight based on a whole amount of the (meth)acrylic resin. On the other hand, the upper limit of the range of the content of the aforementioned monomer in the (meth)acrylic resin is usually 99% by weight. When the content of the aforementioned monomer in the (meth)acrylic resin falls within the aforementioned specific range, the resulting film is more likely to exhibit good adhesion properties.

Also, in order to improve adhesion properties of the resulting film, the glass transition point of the monomer whose homopolymer has a glass transition point of not higher than 0° C. is usually not higher than −20° C., preferably not higher than −30° C., more preferably not higher than −40° C., and even more preferably not higher than −50° C. The lower limit of the glass transition point of the monomer whose homopolymer has a glass transition point of not higher than 0° C. is usually −100° C. By controlling a glass transition point of the monomer whose homopolymer has a glass transition point of not higher than 0° C. to the aforementioned specific range, it is possible to readily produce a film having adequate adhesion properties.

The more optimum configuration of the (meth)acrylic resin for improving adhesion properties of the resulting film is as follows. That is, the total content of n-butyl acrylate and 2-ethylhexyl acrylate in the (meth)acrylic resin is usually in the range of not less than 30% by weight, preferably not less than 40% by weight, more preferably not less than 50% by weight, even more preferably not less than 60% by weight and most preferably not less than 70% by weight. The upper limit of the total content of n-butyl acrylate and 2-ethylhexyl acrylate in the (meth)acrylic resin is usually 99% by weight. In particular, in the case where it is intended to eliminate transfer of the adhesive component to an adherend even when using a small amount of the crosslinking agent, the content of 2-ethylhexyl acrylate in the (meth)acrylic resin is usually in the range of not more than 90% by weight and preferably not more than 80% by weight, though the content of 2-ethylhexyl acrylate in the (meth)acrylic resin may vary depending upon the composition of the (meth)acrylic resin used as well as the composition of the adhesive layer formed.

The glass transition point of the (meth)acrylic resin for improving adhesion properties of the resulting film is usually in the range of not higher than 0° C., preferably not higher than −10° C., more preferably not higher than −20° C. and even more preferably not higher than −30° C. The lower limit of the glass transition point of the (meth)acrylic resin is usually −80° C. By controlling the glass transition point of the (meth)acrylic resin to the aforementioned specific range, it is possible to readily produce a film having optimum adhesion properties. In addition, in the case where it is necessary to reduce transfer of the adhesive component to an adherend, the glass transition point of the (meth)acrylic resin is controlled to the range of usually not lower than −70° C., preferably not lower than −60° C. and more preferably not lower than −50° C.

In addition, in view of applications to in-line coating methods, etc., various hydrophilic functional groups may be introduced to the (meth)acrylic resin in order to render the (meth)acrylic resin usable in an aqueous system. Examples of the preferred hydrophilic functional groups introduced into the (meth)acrylic resin include a carboxylic acid group, a carboxylic acid salt group, a sulfonic acid group, a sulfonic acid salt group and a hydroxyl group. Of these groups, from the standpoint of good water resistance of the resulting film, more preferred are a carboxylic acid group, a carboxylic acid salt group and a hydroxyl group.

In order to introduce a carboxylic acid into the (meth)acrylic resin, various carboxyl group-containing monomers may be copolymerized with the aforementioned polymerizable monomer. Examples of the carboxyl group-containing monomers include acrylic acid, methacrylic acid, crotonic acid, itaconic acid, fumaric acid, maleic acid and citraconic acid. Of these monomers, acrylic acid and methacrylic acid are preferred, since they can be effectively dispersed in water.

In order to introduce a hydroxyl group into the (meth)acrylic resin, various hydroxyl group-containing monomers may be copolymerized with the aforementioned polymerizable monomer. Examples of the hydroxyl group-containing monomers include 2-hydroxyethyl (meth)acrylate, 2-hydroxypropyl (meth)acrylate, 4-hydroxybutyl (meth)acrylate, monobutylhydroxyl fumarate and monobutylhydroxyl itaconate.

Also, a copolymer of an amino group-containing monomer such as dimethylaminoethyl (meth)acrylate or a copolymer of an epoxy group-containing monomer such as glycidyl (meth)acrylate may be incorporated as a crosslinking reaction group into the (meth)acrylic resin. However, if the content of the crosslinking reaction group in the (meth)acrylic resin is excessively large, adhesion properties of the resulting film tend to be adversely affected. Therefore, it is necessary that the amount of the crosslinking reaction group introduced into the (meth)acrylic resin is controlled to an adequate range.

The content of the hydrophilic functional group-containing monomer in the (meth)acrylic resin is usually in the range of not more than 30% by weight, preferably 1 to 20% by weight, more preferably 2 to 15% by weight and even more preferably 3 to 10% by weight. When the content of the hydrophilic functional group-containing monomer in the (meth)acrylic resin lies within the aforementioned specific range, the resulting (meth)acrylic resin can be readily applied to an aqueous system.

In addition, from the standpoint of attaining high strength of the adhesive layer, a crosslinking agent is preferably used in combination with the resin. The main study has been made on the adhesive layer using the (meth)acrylic resin comprising not less than 20% by weight of a (meth)acrylate unit that comprise an alkyl group having not less than 4 carbon atoms at an ester end thereof. However, during the study, it has been found that under severe conditions, the adhesive component is undesirably transferred to an adherend depending on the kind of (meth)acrylic resin used. As a result of various further studies for solving this problem, it has been found that the transfer of the adhesive layer to the adherend can be improved by using a crosslinking agent in combination with the resin.

As the crosslinking agent, there may be used conventionally known materials. Examples of the crosslinking agent include a melamine compound, an isocyanate-based compound, an epoxy compound, an oxazoline compound, a carbodiimide-based compound, a silane coupling compound, a hydrazide compound, an aziridine compound, etc. Among these crosslinking agents, preferred are a melamine compound, an isocyanate-based compound, an epoxy compound, an oxazoline compound, a carbodiimide-based compound and a silane coupling compound, and further from the standpoint of adequately maintaining and readily controlling adhesion strength of the resulting film, more preferred are a melamine compound, an isocyanate-based compound and an epoxy compound. In particular, even more preferred are an isocyanate-based compound and an epoxy compound since these compounds are effective to suppress deterioration in adhesion strength of the resulting film when using them in combination with each other. Furthermore, in particular, from the standpoint of reducing transfer of the adhesive layer to the adherend, even more preferred are a melamine compound and an isocyanate-based compound, and further even more preferred is a melamine compound. In addition, from the standpoint of high strength of the adhesive layer, particularly preferred is a melamine compound. These crosslinking agents may be used singly or in combination of any two or more thereof.

According to construction of the adhesive layer or the kind of crosslinking agent, when the content of the crosslinking agent in the adhesive layer is excessively large, the resulting film tends to be deteriorated in adhesion properties in some cases. Therefore, in such a case, it is required to take care of a content of the crosslinking agent in the adhesive layer.

The melamine compound is a compound having a melamine skeleton therein. Examples of the melamine compound include alkylolated melamine derivatives, partially or completely etherified compounds obtained by reacting the alkylolated melamine derivative with an alcohol, and mixtures of these compounds. Examples of the alcohol suitably used for the above etherification include methyl alcohol, ethyl alcohol, isopropyl alcohol, n-butanol and isobutanol. The melamine compound may be either a monomer or a dimer or higher polymer, or may be in the form of a mixture thereof. In view of good reactivity with various compounds, the melamine compound preferably comprises a hydroxyl group. In addition, there may also be used those compounds obtained by subjecting a urea or the like to co-condensation with a part of melamine. Further, a catalyst may also be used to enhance reactivity of the resulting melamine compound.

The isocyanate-based compound includes an isocyanate and a compound having an isocyanate derivative structure such as typically a blocked isocyanate. Examples of the isocyanate include aromatic isocyanates such as tolylene diisocyanate, xylylene diisocyanate, methylene diphenyl diisocyanate, phenylene diisocyanate and naphthalene diisocyanate; aromatic ring-containing aliphatic isocyanates such as □,□,□′,□′-tetramethyl xylylene diisocyanate; aliphatic isocyanates such as methylene diisocyanate, propylene diisocyanate, lysine diisocyanate, trimethyl hexamethylene diisocyanate and hexamethylene diisocyanate; and alicyclic isocyanates such as cyclohexane diisocyanate, methyl cyclohexane diisocyanate, isophorone diisocyanate, methylene-bis(4-cyclohexyl isocyanate) and isopropylidene dicyclohexyl diisocyanate. Further examples of the isocyanate include polymers and derivatives of these isocyanates such as biuret compounds, isocyanurate compounds, uretdione compounds and carbodiimide-modified compounds thereof. These isocyanates may be used alone or in combination of any two or more thereof. Of these isocyanates, in view of avoiding yellowing due to irradiation with ultraviolet rays, aliphatic isocyanates and alicyclic isocyanates are more suitably used as compared to aromatic isocyanates.

When the isocyanate-based compound is used in the form of a blocked isocyanate, examples of blocking agents used for production thereof include bisulfites; phenol-based compounds such as phenol, cresol and ethyl phenol; alcohol-based compounds such as propylene glycol monomethyl ether, ethylene glycol, benzyl alcohol, methanol and ethanol; active methylene-based compounds such as dimethyl malonate, diethyl malonate, methyl isobutanoyl acetate, methyl acetoacetate, ethyl acetoacetate and acetyl acetone; mercaptan-based compounds such as butyl mercaptan and dodecyl mercaptan; lactam-based compounds such as □-caprolactam and □-valerolactam; amine-based compounds such as diphenyl aniline, aniline and ethylene imine; acid amide compounds such as acetanilide and acetic acid amide; and oxime-based compounds such as formaldehyde, acetaldoxime, acetone oxime, methyl ethyl ketone oxime and cyclohexanone oxime. These blocking agents may be used alone or in combination of any two or more thereof. Among the aforementioned isocyanate-based compounds, in particular, from the standpoint of effectively reducing transfer of the adhesive layer to the adherend, preferred are those isocyanate compounds blocked with the active methylene-based compound.

In addition, the isocyanate-based compounds may be used in the form of a single substance or in the form of a mixture with various polymers or a combined product therewith. The isocyanate-based compounds are preferably used in the form of a mixture or a combined product with polyester resins or urethane resins from the standpoint of improving dispersibility or crosslinkability of the isocyanate-based compounds.

The epoxy compound is a compound having an epoxy group in a molecule thereof. Examples of the epoxy compound include condensation products of epichlorohydrin with a hydroxyl group of ethylene glycol, polyethylene glycol, glycerol, polyglycerol, bisphenol A, etc., or an amino group. Specific examples of the epoxy compound include polyepoxy compounds, diepoxy compounds, monoepoxy compounds and glycidyl amine compounds. Examples of the polyepoxy compounds include sorbitol polyglycidyl ether, polyglycerol polyglycidyl ether, pentaerythritol polyglycidyl ether, diglycerol polyglycidyl ether, triglycidyl tris(2-hydroxyethyl)isocyanate, glycerol polyglycidyl ether and trimethylolpropane polyglycidyl ether. Examples of the diepoxy compounds include neopentyl glycol diglycidyl ether, 1,6-hexanediol diglycidyl ether, resorcin diglycidyl ether, ethylene glycol diglycidyl ether, polyethylene glycol diglycidyl ether, propylene glycol diglycidyl ether, polypropylene glycol diglycidyl ether and polytetramethylene glycol diglycidyl ether. Examples of the monoepoxy compounds include allyl glycidyl ether, 2-ethylhexyl glycidyl ether and phenyl glycidyl ether. Examples of the glycidyl amine compounds include N,N,N′,N′-tetraglycidyl-m-xylylenediamine and 1,3-bis(N,N-diglycidylamino)cyclohexane.

From the standpoint of good adhesion properties of the resulting adhesive layer, among the above epoxy compounds, preferred are polyether-based epoxy compounds. As to the number of epoxy groups in the epoxy compounds, tri- or higher-functional polyfunctional poly epoxy compounds are more preferably used than bifunctional epoxy compounds.

The oxazoline compound is a compound having an oxazoline group in a molecule thereof. In particular, the oxazoline compound is preferably in the form of a polymer having an oxazoline group which may be either a homopolymer of an addition-polymerizable oxazoline group-containing monomer or a copolymer of the addition-polymerizable oxazoline group-containing monomer with the other monomer(s). Examples of the addition-polymerizable oxazoline group-containing monomer include 2-vinyl-2-oxazoline, 2-vinyl-4-methyl-2-oxazoline, 2-vinyl-5-methyl-2-oxazoline, 2-isopropenyl-2-oxazoline, 2-isopropenyl-4-methyl-2-oxazoline and 2-isopropenyl-5-ethyl-2-oxazoline. These oxazoline compounds may be used alone or in the form of a mixture of any two or more thereof. Among these oxazoline compounds, 2-isopropenyl-2-oxazoline is more preferred because of good industrial availability thereof. The other monomers used in the copolymer are not particularly limited as long as they are monomers that are copolymerizable with the addition-polymerizable oxazoline group-containing monomer. Examples of the other monomers include (meth)acrylic acid esters such as alkyl (meth)acrylates (in which the alkyl group may be methyl, ethyl, n-propyl, isopropyl, n-butyl, isobutyl, t-butyl, 2-ethylhexyl, cyclohexyl or the like); unsaturated carboxylic acids such as acrylic acid, methacrylic acid, itaconic acid, maleic acid, fumaric acid, crotonic acid, styrenesulfonic acid and salts thereof (such as sodium salts, potassium salts, ammonium salts and tertiary amine salts); unsaturated nitriles such as acrylonitrile and methacrylonitrile; unsaturated amides such as (meth)acrylamide, N-alkyl (meth)acrylamides and N,N-dialkyl (meth)acrylamides (in which the alkyl group may be methyl, ethyl, n-propyl, isopropyl, n-butyl, isobutyl, t-butyl, 2-ethylhexyl, cyclohexyl or the like); vinyl esters such as vinyl acetate and vinyl propionate; vinyl ethers such as methyl vinyl ether and ethyl vinyl ether; □-olefins such as ethylene and propylene; halogen-containing □,□-unsaturated monomers such as vinyl chloride, vinylidene chloride and vinyl fluoride; and □,□-unsaturated aromatic monomers such as styrene and □-methyl styrene. These other monomers may be used alone or in combination of any two or more thereof.

The amount of an oxazoline group present in the oxazoline compound is usually in the range of 0.5 to 10 mmol/g, preferably 1 to 9 mmol/g, more preferably 3 to 8 mmol/g, and even more preferably 4 to 6 mmol/g. When controlling the amount of an oxazoline group present in the oxazoline compound to the aforementioned specific range, the resulting film can be improved in durability, and therefore it is possible to readily control adhesion properties of the resulting film.

The carbodiimide-based compound is in the form of a compound having one or more carbodiimide structures or carbodiimide derivative structures in a molecule thereof, and the preferred carbodiimide-based compound is a polycarbodiimide-based compound having two or more carbodiimide structures or carbodiimide derivative structures in a molecule thereof in view of attaining higher strength of the resulting adhesive layer or the like.

The carbodiimide-based compound may be synthesized by conventionally known techniques. In general, the carbodiimide-based compound may be obtained by a condensation reaction of a diisocyanate compound. The diisocyanate compound used in the reaction is not particularly limited, and may be either an aromatic diisocyanate or an aliphatic diisocyanate. Specific examples of the diisocyanate compound include tolylene diisocyanate, xylene diisocyanate, diphenylmethane diisocyanate, phenylene diisocyanate, naphthalene diisocyanate, hexamethylene diisocyanate, trimethyl hexamethylene diisocyanate, cyclohexane diisocyanate, methyl cyclohexane diisocyanate, isophorone diisocyanate, dicyclohexyl diisocyanate and dicyclohexylmethane diisocyanate.

Further, in order to improve water solubility or water dispersibility of the polycarbodiimide-based compound, a surfactant or a hydrophilic monomer such as a polyalkyleneoxide, a quaternary ammonium salt of a dialkylamino alcohol and a hydroxyalkyl sulfonic acid salt may be added thereto unless the addition thereof eliminates the effects of the present invention.

The silane coupling compound is in the form of an organosilicon compound comprising an organic functional group and a hydrolyzable group such as an alkoxy group in a molecule thereof. Examples of the silane coupling compound include epoxy group-containing compounds such as 3-glycidoxypropylmethyl dimethoxysilane, 3-glycidoxypropyl trimethoxysilane, 3-glycidoxypropylmethyl diethoxysilane, 3-glycidoxypropyl triethoxysilane and 2-(3,4-epoxycyclohexyl)ethyl trimethoxysilane; vinyl group-containing compounds such as vinyl trimethoxysilane and vinyl triethoxysilane; styryl group-containing compounds such as p-styryl trimethoxysilane and p-styryl triethoxysilane; (meth)acryl group-containing compounds such as 3-(meth)acryloxypropyl trimethoxysilane, 3-(meth)acryloxypropyl triethoxysilane, 3-(meth)acryloxypropylmethyl dimethoxysilane and 3-(meth)acryloxypropylmethyl diethoxysilane; amino group-containing compounds such as 3-aminopropyl trimethoxysilane, 3-aminopropyl triethoxysilane, N-2-(aminoethyl)-3-aminopropyl trimethoxysilane, N-2-(aminoethyl)-3-aminopropyl triethoxysilane, N-2-(aminoethyl)-3-aminopropylmethyl dimethoxysilane, N-2-(aminoethyl)-3-aminopropylmethyl diethoxysilane, 3-triethoxysilyl-N-(1,3-dimethylbutylidene)propyl amine, N-phenyl-3-aminopropyl trimethoxysilane and N-phenyl-3-aminopropyl triethoxysilane; isocyanurate group-containing compounds such as tris(trimethoxysylylpropyl)isocyanurate and tris(triethoxysylylpropyl)isocyanurate; and mercapto group-containing compounds such as 3-mercaptopropyl trimethoxysilane, 3-mercaptopropyl triethoxysilane, 3-mercaptopropylmethyl dimethoxysilane and 3-mercaptopropylmethyl diethoxysilane.

Among the aforementioned compounds, from the standpoint of keeping good mechanical strength and adhesion strength of the adhesive layer, more preferred are epoxy group-containing silane coupling compounds, double bond-containing silane coupling compounds having a double bond such as a vinyl group and a (meth)acryl group, and amino group-containing silane coupling compounds.

Meanwhile, these crosslinking agents are designed and used for improving performance of the adhesive layer by allowing the crosslinking agents to react with the compounds contained in the adhesive layer during a drying step or a film-forming step. Therefore, it is estimated that the resulting adhesive layer comprises the unreacted crosslinking agent, compounds obtained after the reaction, or a mixture thereof.

In addition, from the standpoint of good appearance of the adhesive layer, well-controlled adhesion strength of the adhesive layer, increased strength of the adhesive layer, good adhesiveness to the base material film, good anti-blocking properties and prevention of transfer of the adhesive component to an adherend, the resins other than the (meth)acrylic resin comprising not less than 20% by weight of a (meth)acrylate unit that comprise an alkyl group having not less than 4 carbon atoms at an ester end thereof may also be used in combination with the aforementioned resin. As the resins other than the aforementioned (meth)acrylic resin, there may be used conventionally known materials. Examples of the conventionally known materials as the other resins include a (meth)acrylic resin not belonging to the aforementioned (meth)acrylic resin, a polyester resin, a urethane resin and a polyvinyl resin (such as polyvinyl alcohol and a vinyl chloride/vinyl acetate copolymer, etc.). In view of good influence on appearance and adhesion strength of the adhesive layer, more preferred is a resin selected from the group consisting of the (meth)acrylic resin, the polyester resin and the urethane resin. However, the aforementioned resin has such a fear of causing considerable deterioration in adhesion strength of the resulting film according to the method of using the resin. Therefore, care should be paid upon using such a resin. In order to prevent considerable deterioration in adhesion strength of the resulting film, a resin having a low glass transition point, for example, a resin having a glass transition point of not higher than 0° C. may be preferably used in some cases. On the contrary, in order to suppress transfer of the adhesive component to an adherend, a resin having a relatively high glass transition point may be preferably used in some cases. For example, a resin having a glass transition point of higher than 0° C. may be preferably used in combination with the aforementioned resin.

Also, for the purpose of improving anti-blocking properties and slipping properties of the resulting film as well as well controlling adhesion properties thereof, particles may be used in combination with the aforementioned components for forming the adhesive layer. However, the inclusion of the particles in the adhesive layer tends to sometimes cause deterioration in adhesion strength of the resulting adhesive layer depending upon the kinds of particles used, and therefore care must be taken in such a case. In the case where it is intended to cause no significant deterioration in adhesion strength of the resulting film even upon using the particles in the adhesive layer, the average particle diameter of the particles used in the adhesive layer is usually not more than 3 times, preferably not more than 1.5 times, more preferably not more than 1.0 time, and even more preferably not more than 0.8 time a thickness of the adhesive layer. In particular, in the case where it is intended to directly exhibit an adhesion performance of the resin in the adhesive layer as such, it may be desirable in some cases to incorporate no particles into the adhesive layer.

On the surface of the adhesive film of the present invention which is opposed to the surface on which the adhesive layer is provided, there may be formed any functional layer for imparting various functions to the film.

For example, in order to reduce occurrence of blocking of the film owing to the adhesive layer, a release layer is preferably provided on the opposite surface of the film. Also, in a preferred embodiment of the adhesive film of the present invention, in order to prevent defects owing to deposition of surrounding contaminants, etc., which are caused by peeling electrification or frictional electrification of the film, an antistatic layer may be provided on the opposite surface of the film. The functional layer may be provided by a coating method, and may be formed by either an in-line coating method or an off-line coating method. From the standpoint of low production cost as well as stabilization of releasing performance and antistatic performance of the resulting film when subjected to in-line heat treatment, among these methods, the in-line coating method is preferably used.

For example, in the case where the release functional layer is provided on the surface of the adhesive film opposed to the surface on which the adhesive layer is provided, a release agent used in the release functional layer is not particularly limited, and there may be used any conventionally known release agents. Examples of the release agent include a long-chain alkyl group-containing compound, a fluorine compound, a silicone compound, a wax, etc. Among these release agents, from the standpoint of less contamination and excellent capability of reducing occurrence of blocking, the long-chain alkyl group-containing compound and the fluorine compound are preferably used. In particular, in the case of attaching importance to reduction in occurrence of blocking, the silicone compound is preferably used. In addition, in order to improve decontamination properties on the surface of the film, the wax is effectively used. These release agents may be used alone or in combination of any two or more thereof.

The long-chain alkyl group-containing compound is a compound comprising a linear or branched alkyl group usually having not less than 6 carbon atoms, preferably not less than 8 carbon atoms, and more preferably not less than 12 carbon atoms. Examples of the alkyl group of the long-chain alkyl group-containing compound include a hexyl group, an octyl group, a decyl group, a lauryl group, an octadecyl group, a behenyl group, etc. Examples of the long-chain alkyl group-containing compound include various compounds such as a long-chain alkyl group-containing polymer compound, a long-chain alkyl group-containing amine compound, a long-chain alkyl group-containing ether compound, a long-chain alkyl group-containing quaternary ammonium salt, etc. In view of good heat resistance and decontamination properties of the resulting film, the polymer compound is preferred. Also, from the standpoint of effectively attaining good releasing properties, the polymer compound comprising a long-chain alkyl group on a side chain thereof is more preferred.

The polymer compound comprising a long-chain alkyl group on a side chain thereof may be produced by reacting a polymer comprising a reactive group with a compound comprising an alkyl group capable of reacting with the reactive group. Examples of the reactive group include a hydroxyl group, an amino group, a carboxyl group, an acid anhydride, etc. Examples of the compounds comprising these reactive groups include polyvinyl alcohol, polyethylene imine, polyethylene amine, reactive group-containing polyester resins, reactive group-containing poly(meth)acrylic resins, etc. Of these polymer compounds, in view of good releasing properties and easiness of handling, preferred is polyvinyl alcohol.

Examples of the compound comprising an alkyl group capable of reacting with the reactive group include long-chain alkyl group-containing isocyanates such as hexyl isocyanate, octyl isocyanate, decyl isocyanate, lauryl isocyanate, octadecyl isocyanate and behenyl isocyanate; long-chain alkyl group-containing organic chlorides such as hexyl chloride, octyl chloride, decyl chloride, lauryl chloride, octadecyl chloride and behenyl chloride; long-chain alkyl group-containing amines; long-chain alkyl group-containing alcohols; and the like. Of these compounds, in view of good releasing properties and easiness of handling, preferred are long-chain alkyl group-containing isocyanates, and more preferred is octadecyl isocyanate.

In addition, the polymer compound comprising a long-chain alkyl group on a side chain thereof may also be produced by polymerizing a long-chain alkyl (meth)acrylate or copolymerizing the long-chain alkyl (meth)acrylate with the other vinyl group-containing monomer. Examples of the long-chain alkyl (meth)acrylate include hexyl (meth)acrylate, octyl (meth)acrylate, decyl (meth)acrylate, lauryl (meth)acrylate, octadecyl (meth)acrylate, behenyl (meth)acrylate, etc.

The above fluorine compound is a compound comprising a fluorine atom therein. From the standpoint of a good coating appearance of the adhesive layer formed by the in-line coating method, among these fluorine compounds, organic fluorine compounds are preferably used. Examples of the organic fluorine compounds include perfluoroalkyl group-containing compounds, polymers of fluorine atom-containing olefin compounds, and aromatic fluorine compounds such as fluorobenzene. In view of good releasing properties of the resulting film, preferred are the perfluoroalkyl group-containing compounds. Further, as the fluorine compound, there may also be used those compounds including the below-mentioned long-chain alkyl compounds.

Examples of the perfluoroalkyl group-containing compounds include perfluoroalkyl group-containing (meth)acrylates such as perfluoroalkyl (meth)acrylates, perfluoroalkyl methyl (meth)acrylates, 2-perfluoroalkyl ethyl (meth)acrylates, 3-perfluoroalkyl propyl (meth)acrylates, 3-perfluoroalkyl-1-methyl propyl (meth)acrylates and 3-perfluoroalkyl-2-propenyl (meth)acrylates, or polymers thereof; perfluoroalkyl group-containing vinyl ethers such as perfluoroalkyl methyl vinyl ethers, 2-perfluoroalkyl ethyl vinyl ethers, 3-perfluoropropyl vinyl ether, 3-perfluoroalkyl-1-methyl propyl vinyl ethers and 3-perfluoroalkyl-2-propenyl vinyl ethers, or polymers thereof; and the like. Of these perfluoroalkyl group-containing compounds, in view of good heat resistance and decontamination properties of the resulting film, preferred are the polymers. The polymers may be produced from either a single compound solely or a plurality of compounds. In addition, in view of good releasing properties of the resulting film, the perfluoroalkyl groups preferably have 3 to 11 carbon atoms. Furthermore, the perfluoroalkyl group-containing compounds may also be in the form of a polymer of the perfluoroalkyl group-containing compound with a compound comprising the below-mentioned long-chain alkyl compound. Furthermore, from the standpoint of good adhesion properties of the film to the base material thereof, the polymer with vinyl chloride is also preferred.

The above silicone compound is a compound having a silicone structure in a molecule thereof. Examples of the silicone compound include alkyl silicones such as dimethyl silicone and diethyl silicone, phenyl group-containing silicones such as phenyl silicone and methyl phenyl silicone, etc. As the silicone compound, there may also be used those silicone compounds comprising various functional groups. Examples of the functional groups include an ether group, a hydroxyl group, an amino group, an epoxy group, a carboxyl group, a halogen group such as a fluorine group, a perfluoroalkyl group, a hydrocarbon group such as various alkyl groups and various aromatic groups, and the like. Also, as the silicones comprising the other functional groups, there are generally known silicones comprising a vinyl group and hydrogen silicones comprising a silicon atom to which a hydrogen atom is directly bonded. In addition, addition-type silicones obtained by using both kinds of the aforementioned silicones in combination (i.e., silicones of such a type as produced by addition reaction between the vinyl group and hydrogen silane) may also be used.

Furthermore, as the silicone compound, there may also be used modified silicones such as an acryl-grafted silicone, a silicone-grafted acrylic compound, an amino-modified silicone and a perfluoroalkyl-modified silicone. In view of good heat resistance and decontamination properties of the resulting film, among these silicone compounds, preferred are curable-type silicone resins. As the curable-type silicone resins, there may be used any kinds of curing reaction-type silicones such as condensation type silicones, addition type silicones, active energy ray-curable type silicones, etc. Among the aforementioned silicone compounds, from the standpoint of less transfer of the compounds onto a rear side surface of the film when taking up the film into a roll, preferred is the condensation type silicone compound.

The preferred form of the silicone compound used in the present invention is a polyether group-containing silicone compound from the standpoint of less transfer of the compounds onto a rear side surface of the film, good dispersibility in an aqueous solvent and high adaptability to in-line coating. The polyether group of the polyether group-containing silicone compound may be bonded to a side chain or a terminal end of the silicone compound, or may be bonded to a main chain of the silicone compound. From the standpoint of good dispersibility in an aqueous solvent, the polyether group is preferably bonded to a side chain or terminal end of the silicone compound.

The polyether group of the polyether group-containing silicone compound used in the present invention may have a conventionally known structure. From the standpoint of good dispersibility in an aqueous solvent, as the polyether group, an aliphatic polyether group is preferred as compared to an aromatic polyether group. Among the aliphatic polyether groups, more preferred are alkyl polyether groups. Also, from the standpoint of less problems upon synthesis owing to steric hindrance, straight-chain alkyl polyether groups are more preferred as compared to branched alkyl polyether groups. Among the straight-chain alkyl polyether groups, even more preferred are polyether groups comprising a straight-chain alkyl group having not more than 8 carbon atoms. In addition, when water is used as a developing solvent, in view of good dispersibility in water, a polyethylene glycol group or a polypropylene glycol group is preferred, and a polyethylene glycol group is particularly optimum.

The number of ether bonds in the polyether group is usually in the range of 1 to 30, preferably 2 to 20, and more preferably 3 to 15, from the standpoint of good dispersibility in an aqueous solvent and good durability of the resulting functional layer. When the number of ether bonds in the polyether group is excessively small, the polyether group-containing silicone compound tends to be deteriorated in dispersibility in the aqueous solvent. On the other hand, when the number of ether bonds in the polyether group is excessively large, the polyether group-containing silicone compound tends to cause deterioration in durability of the functional layer or releasing properties of the resulting film.

In the case where the polyether group of the polyether group-containing silicone compound is located at a side chain or a terminal end of the silicone compound, the terminal end of the polyether group is not particularly limited, and may include various functional groups such as a hydroxyl group, an amino group, a thiol group, a hydrocarbon group such as an alkyl group and a phenyl group, a carboxyl group, a sulfonic group, an aldehyde group, an acetal group, etc. Of these functional groups, in view of good dispersibility in water and good crosslinking properties for enhancing strength of the resulting functional layer, preferred are a hydroxyl group, an amino group, carboxyl group and a sulfonic group, and more preferred is a hydroxyl group.

The content of the polyether group in the polyether group-containing silicone compound in terms of a molar ratio thereof as calculated assuming that a molar amount of a siloxane bond in the silicone compound is 1, is usually in the range of 0.001 to 0.30%, preferably 0.01 to 0.20%, more preferably 0.03 to 0.15%, and even more preferably 0.05 to 0.12%. When adjusting the content of the polyether group to the aforementioned specific range, it is possible to maintain good dispersibility of the compound in water as well as good durability and releasing properties of the resulting functional layer.

The molecular weight of the polyether group-containing silicone compound is preferably not so large in view of good dispersibility in an aqueous solvent, whereas the molecular weight of the polyether group-containing silicone compound is preferably large in view of good durability or releasing performance of the resulting functional layer. It has been demanded to achieve good balance between both of the aforementioned properties, i.e., between the dispersibility in an aqueous medium and the durability or releasing performance of the functional layer. The number-average molecular weight of the polyether group-containing silicone compound is usually in the range of 1000 to 100000, preferably 3000 to 30000, and more preferably 5000 to 10000.

In addition, in view of less deterioration in properties of the functional layer with time and good releasing performance thereof as well as anti-contamination properties in various steps, the content of low-molecular weight components (those having a number-average molecular weight of not more than 500) in the silicone compound is preferably as small as possible. The content of the low-molecular weight components in the silicone compound is preferably in the range of not more than 15% by weight, more preferably not more than 10% by weight and even more preferably not more than 5% by weight based on a whole amount of the silicone compound. When using the condensation type silicone, if the vinyl group bonded to silicon (vinyl silane) and the hydrogen group bonded to silicon (hydrogen silane) remain unreacted as such in the functional layer, the resulting functional layer tends to suffer from deterioration in various properties with time. Therefore, the content of the functional groups in the silicone compound is preferably not more than 0.1 mol %. Further, it is more preferred that the silicone compound comprises none of the functional groups.

Since it is difficult to apply the polyether group-containing silicone compound solely onto the film, the polyether group-containing silicone compound is preferably used in the form of a dispersion thereof in water. In order to disperse the polyether group-containing silicone compound in water, there may be used various conventionally known dispersants. Examples of the dispersants include an anionic dispersant, a nonionic dispersant, a cationic dispersant and an amphoteric dispersant. Of these dispersants, in view of good dispersibility of the polyether group-containing silicone compound and good compatibility thereof with a polymer other than the polyether group-containing silicone compound which is used for forming the functional layer, preferred are an anionic dispersant and a nonionic dispersant. As the dispersant, there may also be used a fluorine compound.

Examples of the anionic dispersant include sulfonic acid salt-based compounds and sulfuric acid ester salt-based compounds such as sodium dodecylbenzenesulfonate, sodium alkylsulfonates, sodium alkylnaphthalenesulfonates, sodium dialkylsulfosuccinates, sodium polyoxyethylene alkylethersulfates, sodium polyoxyethylene alkylallylethersulfates and polyoxyalkylene alkenylethersulfuric acid ammonium salts; carboxylic acid salt-based compounds such as sodium laurate and potassium oleate; and phosphoric acid salt-based compounds such as alkyl phosphoric acid salts, polyoxyethylene alkyl ether phosphoric acid salts and polyoxyethylene alkyl phenyl ether phosphoric acid salts. Of these anionic dispersants, from the standpoint of good dispersibility, preferred are sulfonic acid salt-based compounds.

Examples of the nonionic dispersant include ether-type nonionic dispersants obtained by adding an alkyleneoxide such as ethyleneoxide and propyleneoxide to a hydroxyl group-containing compound such as a higher alcohol and an alkyl phenol; ester-type nonionic dispersants obtained by an ester bond between a polyhydric alcohol such as glycerol and sugars, and a fatty acid; ester-ether-type nonionic dispersants obtained by adding an alkyleneoxide to a fatty acid or a polyhydric alcohol fatty acid ester; amide-type nonionic dispersants comprising a hydrophobic group and a hydrophilic group that are bonded through an amide bond therebetween; and the like. Of these nonionic dispersants, in view of good solubility in water and good stability, preferred are the ether-type nonionic dispersants, and in view of good handling properties in addition to the aforementioned properties, more preferred are the ether-type nonionic dispersants obtained by adding ethyleneoxide to the hydroxy group-containing compound.

The amount of the dispersant used may vary depending upon the molecular weight and structure of the polyether group-containing silicone compound used as well as the kind of dispersant used, and therefore is not particularly limited. However, the amount of the dispersant used may be controlled, as a measure, such that the weight ratio thereof to the polyether group-containing silicone compound as calculated assuming that the amount of the polyether group-containing silicone compound is 1, is usually in the range of 0.01 to 0.5, preferably 0.05 to 0.4, and more preferably 0.1 to 0.3.

The aforementioned wax usable in the present invention includes those waxes selected from natural waxes, synthetic waxes and mixtures of these waxes. Examples of the natural waxes include vegetable waxes, animal waxes, mineral waxes and petroleum waxes. Specific examples of the vegetable waxes include candelilla waxes, carnauba waxes, rice waxes, haze waxes and jojoba oils. Specific examples of the animal waxes include beeswaxes, lanolin and spermaceti waxes. Specific examples of the mineral waxes include montan waxes, ozokerite and ceresin. Specific examples of the petroleum waxes include paraffin waxes, microcrystalline waxes and petrolatum. Specific examples of the synthetic waxes include synthetic hydrocarbons, modified waxes, hydrogenated waxes, fatty acids, acid amides, amines, imides, esters and ketones. As the synthetic hydrocarbons, there may be mentioned, for example, Fischer-Tropsch waxes (alias: Sasol Wax), polyethylene waxes or the like. In addition, those polymers having a low molecular weight (specifically, those polymers having a number-average molecular weight of 500 to 20000) are also included in the synthetic hydrocarbons as the synthetic waxes. Specific examples of the low-molecular weight polymers as the synthetic hydrocarbons include polypropylene, ethylene-acrylic acid copolymers, polyethylene glycol, polypropylene glycol, and blocked or grafted combined products of polyethylene glycol and polypropylene glycol. Specific examples of the modified waxes include montan wax derivatives, paraffin wax derivatives and microcrystalline wax derivatives. The derivatives as used herein mean compounds obtained by subjecting the respective waxes to any treatment selected from refining, oxidation, esterification and saponification, or combination of these treatments. Specific examples of the hydrogenated waxes include hardened castor oils and hardened castor oil derivatives.

Of these waxes, in view of well-stabilized properties thereof, preferred are the synthetic waxes, more preferred are polyethylene waxes, and even more preferred are polyethylene oxide waxes. The number-average molecular weight of the synthetic waxes is usually in the range of 500 to 30000, preferably 1000 to 15000, and more preferably 2000 to 8000, from the standpoint of good stability of properties such as anti-blocking properties and good handling properties.

In the case where the antistatic functional layer is provided on the surface of the adhesive film opposed to the surface on which the adhesive layer is formed, the antistatic agent incorporated in the antistatic functional layer is not particularly limited, and there may be used conventionally known antistatic agents. Among them, in view of good heat resistance and wet heat resistance of the resulting film, preferred are polymer-type antistatic agents. Examples of the polymer-type antistatic agents include an ammonium group-containing compound, a polyether compound, a sulfonic group-containing compound, a betaine compound and a conductive polymer.

The ammonium group-containing compound means a compound comprising an ammonium group in a molecule thereof. Examples of the ammonium group-containing compound include various ammonium compounds such as an aliphatic amine, an alicyclic amine and an aromatic amine. Of these ammonium group-containing compounds, preferred are polymer-type ammonium group-containing compounds. The polymer-type ammonium group-containing compounds preferably have such a structure that the ammonium group is not present as a counter ion but incorporated into a main chain or side chain of the polymer. For example, as the ammonium group-containing compound, there may be mentioned and suitably used those ammonium group-containing high-molecular weight compounds derived from polymers obtained by polymerizing a monomer comprising an addition-polymerizable ammonium group or a precursor of the ammonium group such as an amine. The polymers may be in the form of a homopolymer produced by polymerizing the monomer comprising an addition-polymerizable ammonium group or a precursor of the ammonium group such as an amine solely or a copolymer produced by copolymerizing the aforementioned monomer with the other monomer.

Among the ammonium group-containing compounds, pyrrolidinium ring-containing compounds are also preferably used from the standpoint of excellent antistatic properties and heat resistance/stability of the resulting film.

The two substituent groups bonded to a nitrogen atom of the pyrrolidinium ring-containing compounds are each independently an alkyl group or a phenyl group, etc. The alkyl group or phenyl group may be substituted with the following substituent group. Examples of the substituent group that can be bonded to the alkyl group or phenyl group include a hydroxyl group, an amide group, an ester group, an alkoxy group, a phenoxy group, a naphthoxy group, a thioalkoxy group, a thiophenoxy group, a cycloalkyl group, a trialkyl ammonium alkyl group, a cyano group, and a halogen atom. Also, the two substituent groups bonded to the nitrogen atom may be chemically bonded to each other. Examples of the substituent groups include —(CH₂)ₘ— (m=integer of 2 to 5), —CH(CH₃)CH(CH₃)—, —CH═CH—CH═CH—, —CH═CH—CH═N—, —CH═CH—N═C—, —CH₂OCH₂—, —(CH₂)₂O(CH₂)₂— and the like.

The pyrrolidinium ring-containing polymer may be produced by subjecting a diallylamine derivative to cyclic polymerization using a radical polymerization catalyst. The cyclic polymerization may be carried out in a solvent such as water or a polar solvent such as methanol, ethanol, isopropanol, formamide, dimethylformamide, dioxane and acetonitrile using a polymerization initiator such as hydrogen peroxide, benzoyl peroxide and tertiary butyl peroxide by conventionally known methods, though the present invention is not particularly limited thereto. In the present invention, a compound having a carbon-carbon unsaturated bond that is polymerizable with the diallylamine derivative may be used as a comonomer component thereof.

In addition, from the standpoint of excellent antistatic properties and wet heat resistance/stability of the resulting film, preferred are polymers having the structure represented by the following formula (1). The polymers as the ammonium group-containing compounds may be in the form of a homopolymer or a copolymer, as well as a copolymer obtained by copolymerizing the compounds with a plurality of the other components.

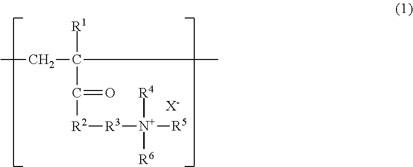

For example, in the above formula (1), the substituent group R¹ is a hydrogen atom or a hydrocarbon group such as an alkyl group having 1 to 20 carbon atoms and a phenyl group; R² is —O—, —NH— or —S—; R³ is an alkylene group having 1 to 20 carbon atoms or the other structure capable of establishing the structure represented by the above formula (1); R⁴, R⁵ and R⁶ are each independently a hydrogen atom, a hydrocarbon group such as an alkyl group having 1 to 20 carbon atoms and a phenyl group, or a hydrocarbon group to which a functional group such as a hydroxyalkyl group is added; and X⁻ represents various counter ions.

Among them, in particular, from the standpoint of excellent antistatic properties and wet heat resistance/stability of the resulting film, in the above formula (1), the substituent R¹ is preferably a hydrogen atom or an alkyl group having 1 to 6 carbon atoms; R³ is preferably an alkyl group having 1 to 6 carbon atoms; and R⁴, R⁵ and R⁶ are preferably each independently a hydrogen atom or an alkyl group having 1 to 6 carbon atoms, and it is more preferred that any one of R⁴, R⁵ and R⁶ is a hydrogen atom, and the other substituent groups are each an alkyl group having 1 to 4 carbon atoms.

Examples of an anion as a counter ion of the ammonium group of the aforementioned ammonium group-containing compound include various ions such as a halogen ion, a sulfonate ion, a phosphate ion, a nitrate ion, an alkyl sulfonate ion and a carboxylate ion.

Also, the number-average molecular weight of the ammonium group-containing compound is usually 1000 to 500000, preferably 2000 to 350000, and more preferably 5000 to 200000. When the number-average molecular weight of the ammonium group-containing compound is less than 1000, the resulting coating film tends to be insufficient in strength or tends to be deteriorated in heat resistance/stability. On the other hand, when the number-average molecular weight of the ammonium group-containing compound is more than 500000, the coating solution tends to have an excessively high viscosity, and therefore tends to be deteriorated in handling properties and coatability.

Examples of the polyether compound include polyethyleneoxide, polyetheresteramides, acrylic resins comprising polyethylene glycol on a side chain thereof, and the like.

The sulfonic group-containing compound means a compound comprising sulfonic acid or a sulfonic acid salt in a molecule thereof. As the sulfonic group-containing compound, there may be suitably used, for example, compounds in which a large amount of sulfonic acid or a sulfonic acid salt is present, such as polystyrene sulfonic acid.

Examples of the conductive polymer include polythiophene-based polymers, polyaniline-based polymers, polypyrrole-based polymers, polyacetylene-based polymers, etc. Among these conductive polymers, there may be suitably used, for example, polythiophene-based polymers such as polymers in which poly(3,4-ethylenedioxythiophene) is used in combination with polystyrene sulfonic acid. The conductive polymers are more suitably used as compared to the aforementioned other antistatic agents, because they have a low resistance value. However, on the other hand, it is necessary to take any measures such as reduction in amount of the conductive polymers used, if the conductive polymers are used in the applications in which coloration and increased costs should be avoided.

In the preferred embodiment of the adhesive film of the present invention, the functional layer provided on the surface of the adhesive film opposed to the surface on which the adhesive layer is formed may also comprise both of the aforementioned release agent and antistatic agent to impart a combined function of the antistatic performance and release performance to the film.

Upon forming the functional layer, in order to improve appearance or transparency of the resulting functional layer and well control slipping properties of the resulting film, it is possible to use various polymers such as polyester resins, acrylic resins and urethane resins as well as crosslinking agents used for forming the adhesive layer in combination with the aforementioned components. In particular, from the standpoint of strengthening the functional layer and reducing occurrence of blocking therein, it is preferred that any of a melamine compound, an oxazoline compound, an isocyanate-based compound, an epoxy compound and a carbodiimide-based compound is used in combination with the aforementioned components. Of these compounds, particularly preferred is the melamine compound.

Also, it is possible to incorporate particles into the functional layer for the purpose of improving anti-blocking properties and slipping properties of the resulting film unless the subject matter of the present invention is adversely influenced by addition of the particles. However, in the case where the functional layer inherently has a release performance, the resulting film may exhibit sufficient anti-blocking properties and slipping properties in many cases. Therefore, it is preferred that the particles are not used in the functional layer having such a release performance in combination with the other components from the standpoint of good appearance of the functional layer.

Furthermore, upon forming the adhesive layer and the functional layer, it is also possible to use various additives such as a defoaming agent, a coatability improver, a thickening agent, an organic lubricant, an antistatic agent, an ultraviolet absorber, an antioxidant, a foaming agent, a dye and a pigment, etc., if required, in combination with the aforementioned components, unless the subject matter of the present invention is adversely affected by addition of these additives.

The content of the (meth)acrylic resin comprising not less than 20% by weight of a (meth)acrylate unit that comprise an alkyl group having not less than 4 carbon atoms at an ester end thereof in the adhesive layer constituting the adhesive film is usually in the range of not less than 20% by weight, preferably 40 to 99.5% by weight, more preferably 55 to 99% by weight, even more preferably 70 to 97% by weight and most preferably 75 to 95% by weight. When the (meth)acrylic resin is used in the aforementioned specific range, it is possible to readily attain sufficient adhesion strength of the resulting film and readily control the adhesion strength. In the case where the content of the above (meth)acrylic resin in the adhesive layer is excessively small, the resulting film tends to be deteriorated in adhesion strength, and therefore it may be sometimes necessary to take any suitable measures such as increase in thickness of the adhesive layer. However, in order to increase the thickness of the adhesive layer, according to a degree of the increase in thickness of the adhesive layer or in some specific cases, it might be required to reduce a speed of a production line upon manufacture of the film, etc., which tends to have adverse influence on productivity of the film. Therefore, care should be taken in such a case.

The content of the crosslinking agent in the adhesive layer constituting the adhesive film is usually in the range of not more than 60% by weight, preferably 0.9 to 40% by weight, more preferably 2 to 29% by weight and even more preferably 7 to 20% by weight. When the crosslinking agent is used in the aforementioned specific range, it is possible to improve mechanical strength of the adhesive layer, reduce an amount of the adhesive layer transferred to an adherend, and readily control adhesion strength of the resulting film. In the case where the content of the crosslinking agent in the adhesive layer is excessively small, the amount of the adhesive layer transferred to an adherend tends to be increased. On the other hand, in the case where the content of the crosslinking agent in the adhesive layer is excessively large, the resulting film tends to be deteriorated in adhesion strength, and therefore it may be sometimes necessary to take any suitable measures such as increase in thickness of the adhesive layer. However, in order to increase the thickness of the adhesive layer, according to a degree of the increase in thickness of the adhesive layer or in some specific cases, it might be required to reduce a speed of a production line upon manufacture of the film, etc., which tends to have adverse influence on productivity of the film. Therefore, care should be taken in such a case.

The content of the particles in the adhesive layer constituting the adhesive film is usually in the range of not more than 50% by weight, preferably 0.1 to 40% by weight, more preferably 0.5 to 20% by weight and even more preferably 1 to 15% by weight. When the particles are used in the aforementioned specific range, it is possible to readily attain sufficient adhesion properties, anti-blocking properties and slipping properties of the resulting film. However, a large amount of the particles used in the adhesive layer tend to sometimes cause deterioration in adhesion properties of the resulting adhesive layer depending upon the composition of the adhesive layer or the kinds of the particles used, and therefore care must be taken in such a case.

In the adhesive film of the present invention, in the case where the functional layer having a release performance is provided on the surface of the adhesive film opposed to the surface on which the adhesive layer is formed, the content of the release agent in the functional layer is not particularly limited since an adequate amount of the release agent to be used in the functional layer may vary depending upon the kind of release agent to be incorporated therein. However, the content of the release agent in the functional layer is usually in the range of not less than 3% by weight, preferably not less than 15% by weight, and more preferably 25 to 99% by weight. When the content of the release agent in the functional layer is less than 3% by weight, it may be difficult to reduce occurrence of blocking in the resulting film to a sufficient extent.

In the case where the long-chain alkyl compound or fluorine compound is used as the release agent, the content of the long-chain alkyl compound or fluorine compound in the functional layer is usually in the range of not less than 5% by weight, preferably 15 to 99% by weight, more preferably 20 to 95% by weight, and even more preferably 25 to 90% by weight. When using the long-chain alkyl compound or fluorine compound in the aforementioned specific range, it is possible to effectively reduce occurrence of blocking in the resulting film. Also, in this case, the content of the crosslinking agent in the functional layer is usually in the range of not more than 95% by weight, preferably 1 to 80% by weight, more preferably 5 to 70% by weight, and even more preferably 10 to 50% by weight. As the crosslinking agent, there are preferably used a melamine compound and an isocyanate-based compound (among them, particularly preferred are blocked isocyanates obtained by blocking isocyanates with an active methylene-based compound), and more preferred is the melamine compound from the standpoint of reducing occurrence of blocking in the resulting film.

When using the condensation-type silicone compound as the release agent, the content of the condensation-type silicone compound in the functional layer is usually in the range of not less than 3% by weight, preferably 5 to 97% by weight, more preferably 8 to 95% by weight, and even more preferably 10 to 90% by weight. When using the condensation-type silicone compound in the aforementioned specific range, it is possible to effectively reduce occurrence of blocking in the resulting film. Also, in this case, the content of the crosslinking agent in the functional layer is usually in the range of not more than 97% by weight, preferably 3 to 95% by weight, more preferably 5 to 92% by weight, and even more preferably 10 to 90% by weight. As the crosslinking agent, there is preferably used a melamine compound from the standpoint of reducing occurrence of blocking in the resulting film.

When using the addition-type silicone compound as the release agent, the content of the addition-type silicone compound in the functional layer is usually in the range of not less than 5% by weight, preferably not less than 25% by weight, more preferably not less than 50% by weight, and even more preferably not less than 70% by weight. The upper limit of the content of the addition-type silicone compound in the functional layer is usually 99% by weight and preferably 90% by weight. When using the addition-type silicone compound in the aforementioned specific range, it is possible to effectively reduce occurrence of blocking in the resulting film, and attain a good appearance of the functional layer.

When using the wax as the release agent, the content of the wax in the functional layer is usually in the range of not less than 10% by weight, preferably 20 to 90% by weight, and more preferably 25 to 70% by weight. When using the wax in the aforementioned specific range, it is possible to effectively reduce occurrence of blocking in the resulting film. However, in the case where the wax is used for the purpose of enhancing decontamination properties on the surface of the resulting film, it is possible to reduce the aforementioned content of the wax in the functional layer. In such a case, the content of the wax in the functional layer is usually in the range of not less than 1% by weight, preferably 2 to 50% by weight, and more preferably 3 to 30% by weight. Also, in this case, the content of the crosslinking agent in the functional layer is usually in the range of not more than 90% by weight, preferably 10 to 70% by weight, and more preferably 20 to 50% by weight. As the crosslinking agent, there is preferably used a melamine compound from the standpoint of reducing occurrence of blocking in the resulting film.

On the other hand, in the case where the functional layer having an antistatic performance is provided on the surface of the adhesive film opposed to the surface on which the adhesive layer is formed, the content of the antistatic agent in the functional layer is not particularly limited since an adequate amount of the antistatic agent used in the functional layer may vary depending upon the kind of antistatic agent to be incorporated therein. However, the content of the antistatic agent in the functional layer is usually in the range of not less than 0.5% by weight, preferably 3 to 90% by weight, more preferably 5 to 70% by weight, and even more preferably 8 to 60% by weight. When the content of the antistatic agent in the functional layer is less than 0.5% by weight, the resulting adhesive film tends to be insufficient in antistatic effect as well as effect of preventing deposition of surrounding contaminants, etc., thereon.

In the case where an antistatic agent other than the conductive polymer is used as the aforementioned antistatic agent, the content of the antistatic agent other than the conductive polymer in the antistatic functional layer is usually in the range of not less than 5% by weight, preferably 10 to 90% by weight, more preferably 20 to 70% by weight, and even more preferably 25 to 60% by weight. When the content of the antistatic agent other than the conductive polymer in the antistatic functional layer is less than 5% by weight, the resulting film tends to be insufficient in antistatic effect as well as effect of preventing deposition of surrounding contaminants, etc., thereon.

In the case where the conductive polymer is used as the aforementioned antistatic agent, the content of the conductive polymer in the antistatic functional layer is usually in the range of not less than 0.5% by weight, preferably 3 to 70% by weight, more preferably 5 to 50% by weight, and even more preferably 8 to 30% by weight. When the content of the conductive polymer in the antistatic functional layer is less than 0.5% by weight, the resulting film tends to be insufficient in antistatic effect as well as effect of preventing deposition of surrounding contaminants, etc., thereon.

The analysis of the components in the adhesive layer or the functional layer may be conducted, for example, by analyzing methods such as TOF-SIMS, ESCA, fluorescent X-ray analysis and IR analysis.

Upon forming the adhesive layer or the functional layer, the adhesive film is preferably produced by the method in which a solution or a solvent dispersion comprising a series of the aforementioned compounds is prepared as a coating solution having a concentration of usually about 0.1 to about 80% by weight in terms of a solid content thereof, and the thus prepared coating solution is applied onto a film. In particular, in the case where the adhesive layer or the functional layer is formed by an in-line coating method, the coating solution is preferably used in the form of an aqueous solution or a water dispersion. The coating solution may also comprise a small amount of an organic solvent for the purpose of improving dispersibility in water, film-forming properties or the like. In addition, the organic solvent may be used alone, or the organic solvents may be appropriately used in combination of any two or more kinds thereof.

The thickness of the adhesive layer may vary depending upon the material used in the adhesive layer and therefore is not particularly limited. In order to more suitably control adhesion strength of the resulting film and improve anti-blocking properties of the film and appearance of the adhesive layer, the thickness of the adhesive layer is usually in the range of not more than 10 μm, preferably 1 nm to 4 μm, more preferably 10 nm to 1 μm, even more preferably 20 to 400 nm and most preferably 30 to 300 nm. In addition, in order to suppress transfer of the adhesive component to an adherend, the thickness of the adhesive layer is preferably small. For example, when the adhesive layer does not include any material capable of suppressing transfer of the adhesive component to an adherend, such as a crosslinking agent, only a method of suppressing the transfer of the adhesive component to an adherend is to control the thickness of the adhesive layer to a small value. Therefore, when it is necessary to suppress the transfer of the adhesive component to an adherend, the thickness of the adhesive layer is usually in the range of not more than 100 nm, and preferably not more than 70 nm.

The adhesive layer generally has a thickness as large as several tens of μm. In such a case, for example, when using the adhesive film for production of a polarizing plate in which the adhesive film is laminated onto an adherend such as a polarizing plate, a retardation plate and a viewing angle widening plate, and the resulting laminate is cut into an appropriate size, squeeze-out of an adhesive included in the adhesive layer tends to remarkably occur in some cases.

However, by controlling the thickness of the adhesive layer to the aforementioned specific range, it is possible to minimize an amount of the adhesive squeezed out. This effect becomes more remarkable as the thickness of the adhesive layer is reduced. In addition, as the thickness of the adhesive layer is reduced, an absolute amount of the adhesive layer present on the film is lessened, and therefore the reduced thickness of the adhesive layer is effective to suppress occurrence of an adhesive residue as adhesive components of the adhesive layer transferred onto the adherend. It has been further found that by controlling the thickness of the adhesive layer to the aforementioned specific range, it is possible to attain adequate adhesion strength of the resulting film without causing excessive increase thereof. Thus, the resulting film can be readily subjected to adhesion-release operations when used in the applications in which it is required to satisfy both of adhesion performance and release performance for releasing the film after being adhered, for example, when used in a process for production of a polarizing plate, etc. As a result, the adhesive film of the present invention is capable of providing an optimum film usable in the aforementioned applications.

As the thickness of the adhesive layer is reduced, the resulting film can be effectively improved in anti-blocking properties. In addition, the reduced thickness of the adhesive layer is preferred since when the adhesive layer is formed by an in-line coating method, production of the film can be facilitated. On the contrary, when the thickness of the adhesive layer is excessively small, there tends to be such a possibility that the resulting film exhibits no adhesion properties depending upon construction of the adhesive layer. For this reason, the thickness of the adhesive layer is preferably controlled to the aforementioned preferred range according to the applications thereof.

The thickness of the functional layer may vary depending upon the functions to be imparted to the film, and therefore is not particularly limited. For example, the thickness of the functional layer for imparting a release performance or an antistatic performance to the film is usually in the range of 1 nm to 3 μm, preferably 10 nm to 1 μm, more preferably 20 to 500 nm, and even more preferably 20 to 200 nm. When the thickness of the functional layer used lies within the aforementioned specific range, the resulting film can be readily improved in anti-blocking properties as well as antistatic performance, and can exhibit a good coating appearance.

As the method of forming the adhesive layer or the functional layer, there may be used conventionally known coating methods such as a gravure coating method, a reverse roll coating method, a die coating method, an air doctor coating method, a blade coating method, a rod coating method, a bar coating method, a curtain coating method, a knife coating method, a transfer roll coating method, a squeeze coating method, an impregnation coating method, a kiss-roll coating method, a spray coating method, a calender coating method, an extrusion coating method, and the like.

The drying and curing conditions used upon forming the adhesive layer on the film are not particularly limited. When forming the adhesive layer by a coating method, the drying temperature upon removing the solvent used in the coating solution, such as water, is usually in the range of 70 to 150° C., preferably 80 to 130° C. and more preferably 90 to 120° C. The drying time is usually in the range of 3 to 200 sec and preferably 5 to 120 sec. In addition, in order to improve strength of the adhesive layer, in the film production process, the adhesive layer is preferably subjected to heat-setting treatment step. The temperature of the heat-setting treatment step is usually in the range of 180 to 270° C., preferably 200 to 250° C. and more preferably 210 to 240° C. The time of the heat-setting treatment step is usually in the range of 3 to 200 sec and preferably 5 to 120 sec.

In addition, the heat-setting treatment may be used in combination with irradiation with active energy rays such as irradiation with ultraviolet rays, if required. The film constituting the adhesive film of the present invention may be previously subjected to surface treatments such as corona treatment and plasma treatment.

It is essentially required that the adhesion strength of the adhesive layer as measured in terms of an adhesion strength to a polymethyl methacrylate plate by the below-mentioned measuring method is in the range of not less than 1 mN/cm. The adhesion strength of the adhesive layer as measured in terms of an adhesion strength to a polymethyl methacrylate plate is preferably in the range of 3 to 3000 mN/cm, more preferably 5 to 500 mN/cm, even more preferably 7 to 300 mN/cm and most preferably 10 to 100 mN/cm. When the adhesion strength of the adhesive layer as measured in terms of an adhesion strength to a polymethyl methacrylate plate is out of the aforementioned specific range, the resulting film tends to suffer from less adhesion strength depending upon the kind of adherend used. In addition, by controlling the adhesion strength of the adhesive layer to an adequate range, application and peeling-off of the film can be easily conducted, and occurrence of blocking of the film can also be prevented.

The arithmetic average roughness (Sa) of the surface of the adhesive layer is usually in the range of not more than 50 nm, preferably not more than 30 nm, more preferably not more than 20 nm, even more preferably not more than 15 nm and most preferably not more than 10 nm. When the Sa value is excessively high, the adhesive layer tends to fail to exhibit sufficient adhesion strength. Further, when the Sa value is excessively high, it may be necessary to control the thickness of the adhesive layer to be of a large value in some cases, and therefore, it may be occasionally difficult to control the adhesion strength of the adhesive layer or suppress transfer of adhesive components of the adhesive layer onto an adherend. Furthermore, the lower limit of the Sa value is not particularly limited, and the lower limit of the preferable range of the Sa value is 1 nm.

The Sa value of the surface of the adhesive layer may be controlled by design of the adhesive layer or design of the polyester film layer on the side contacting with the adhesive layer. When controlling the Sa value by design of the adhesive layer, it is necessary to increase the thickness of the adhesive layer, which results in higher difficulty in designing the adhesive strength of the adhesive layer. Therefore, it is preferred that the Sa value is controlled by design of the polyester film layer.

Upon designing the polyester film layer on the side of the adhesive layer, examples of the main factors having an influence on the Sa value include an average particle diameter of the particles incorporated in the polyester film layer, a content of the particles in the polyester film layer and the thickness of the polyester film layer. Since the Sa value is mainly determined by interrelation between these factors, and it is therefore not possible to determine the Sa value in view of only one of the factors. However, by using the particles having an average particle diameter of usually not more than 5 μm (preferably not more than 3.5 μm) in the polyester film layer, the Sa value of the surface of the adhesive layer can be readily controlled to a low value.

The amount of the particles incorporated in the polyester film layer on the side of the adhesive layer is usually in the range of less than 0.30% by weight, preferably not more than 0.15% by weight, more preferably not more than 0.10% by weight and even more preferably not more than 0.08% by weight. By controlling the amount of the particles incorporated in the polyester film layer to the aforementioned specific range, the Sa value of the surface of the adhesive layer can be readily controlled to a low value.

The thickness of the polyester film layer on the side of the adhesive layer is usually in the range of 0.5 to 10 μm, preferably 1 to 8 μm and more preferably 2 to 6 μm. When using the polyester film layer within the aforementioned thickness range, it is possible to readily control not only the content of the particles in the polyester film layer, but also the Sa value of the surface of the adhesive layer.

The Sa value of the surface of the adhesive layer may vary depending upon the design of the adhesive layer as described above, and therefore is not particularly limited. The Sa value of the surface of the polyester film layer from which the adhesive layer is removed (the surface of the polyester film layer on which no adhesive layer is provided) is usually in the range of not more than 50 nm, preferably not more than 30 nm, more preferably not more than 20 nm, even more preferably not more than 15 nm and most preferably not more than 10 nm. When the Sa value lies within the aforementioned specific range, the Sa value of the surface of the adhesive layer can be more easily controlled.

To evaluate the anti-blocking properties of the adhesive film, the adhesive layer side surface of the adhesive film is overlapped on the opposite side surface (the surface on the side of the functional layer, if any) thereof, and the thus overlapped film is pressed at 40° C. and 80% RH under 10 kg/cm² for 20 hr. The delamination load of the adhesive film after being pressed under the aforementioned conditions is usually in the range of not more than 100 g/cm, preferably not more than 30 g/cm, more preferably not more than 20 g/cm, even more preferably not more than 10 g/cm, and most preferably not more than 8 g/cm. When the delamination load of the adhesive film is controlled so as to fall within the aforementioned specific range, the risk of occurrence of blocking in the film tends to be more readily avoided, so that it is possible to provide the film having a still higher practicability.

In the applications in which it is required to impart antistatic properties to the adhesive film, the surface resistance value of the functional layer is usually in the range of not more than 1×10¹²Ω, preferably not more than 1×10¹¹Ω and more preferably not more than 5×10¹⁰Ω. When the surface resistance value of the functional layer lies within the aforementioned specific range, the resulting film hardly suffers from deposition of dirt and dusts thereon.

In addition, the surface of the adhesive film which is opposed to the surface on which the adhesive layer is formed (i.e., the surface of the adhesive film on the side of the functional layer, if any) may be roughened as one of the methods of improving anti-blocking properties of the surface of the adhesive film against the adhesive layer side thereof. The roughness of the surface of the adhesive film on the side opposed to the adhesive layer may vary depending upon the kind or adhesion strength of the adhesive layer, and therefore is not particularly limited. However, irrespective of whether or not the functional layer is formed on the opposite surface of the film, in the case where it is intended to improve the anti-blocking properties of the film by controlling the surface roughness thereof, the arithmetic average roughness (Sa) of the surface of the adhesive film on the side opposed to the adhesive layer is usually in the range of not less than 5 nm, preferably not less than 8 nm, and more preferably not less than 30 nm. The upper limit of the arithmetic average roughness (Sa) of the surface of the adhesive film on the side opposed to the adhesive layer is not particularly limited. However, the upper limit of the arithmetic average roughness (Sa) of the surface of the adhesive film on the side opposed to the adhesive layer is 300 nm from the standpoint of good transparency of the resulting film. Meanwhile, in the case where the surface of the adhesive film opposed to the surface on which the adhesive layer is formed has good release properties by the method of forming a release functional layer thereon, etc., the good release properties of the surface of the adhesive film on the side opposed to the adhesive layer is predominant and therefore the Sa value thereof has merely a low influence on anti-blocking properties of the film, so that no particular attention to the Sa value needs to be paid. However, in the case where the surface of the adhesive film opposed to the surface on which the adhesive layer is formed has poor release properties, the influence of the Sa value on anti-blocking properties of the film tends to become large, and therefore, in such a case, the well-controlled Sa value may be effective to improve anti-blocking properties of the film, etc. However, if the Sa value is increased, the resulting film tends to have a high haze and therefore tends to be deteriorated in transparency. Thus, it is necessary to take suitable measures according to the applications of the film. In particular, in the case where importance is attached to transparency of the film, it is preferred that a release layer is provided on the film to improve anti-blocking properties thereof.

When the adhesive film is subjected to verification or inspection under the condition that the adhesive film is kept attached on an adherend, the haze value of the adhesive film is desirably as small as possible, and is usually in the range of not more than 5.0%, preferably not more than 3.0%, more preferably not more than 2.0%, even more preferably not more than 1.5% and most preferably not more than 1.0%. In the case where the adhesive film is subjected to inspection for inclusion of foreign matters, etc., by mechanical means rather than visual observation, it is preferred that the adhesive film has a much lower haze value. The lower limit of the haze value of the adhesive film is not particularly limited, and is usually 0.1%. When the haze value of the adhesive film is controlled to the aforementioned specific range, visibility of the adhesive film and linear propagation of light therethrough can be improved, so that it is possible to recognize the condition of the underlying adherend without releasing the polyester film as the protective film even in the case where various inspections or verifications of the adherend are needed.

Since the polyolefin-based film conventionally used as a surface protective film has a high haze (more than about 10%) and is therefore deteriorated in transparency, it is not possible to sufficiently inspect the underlying adherend under the condition that the surface protective film is attached thereonto. Consequently, when inspecting the adherend, it is necessary to purposely release the surface protective film therefrom, which results in time-consuming procedure. Furthermore, there tends to arise such a risk that upon releasing the surface protective film, defects such as deposition of foreign matters and formation of flaws on the adherend are caused. Therefore, there is a demand for such a surface protective film having low haze and high transparency which enables the underlying adherend to undergo its inspection under the condition that the surface protective film is kept attached thereonto.

### EXAMPLES

The present invention is described in more detail below by referring to the following Examples. However, these Examples are only illustrative and not intended to limit the present invention thereto, and other changes or modifications are also possible unless they depart from the scope of the present invention. In addition, the measuring and evaluating methods used in the present invention are as follows.

### (1) Method of Measuring Intrinsic Viscosity of Polyester:

One gram of a polyester from which the other polymer components incompatible with the polyester and pigments were previously removed was accurately weighed, and mixed and dissolved in 100 mL of a mixed solvent comprising phenol and tetrachloroethane at a weight ratio of 50:50, and a viscosity of the resulting solution was measured at 30° C.

(2) Method of Measuring Average Particle Diameter (d50; μm) of Particles:

Using a centrifugal precipitation type particle size distribution measuring apparatus “SA-CP3 Model” manufactured by Shimadzu Corp., the particle size corresponding to a cumulative fraction of 50% (on a weight basis) in equivalent spherical distribution of the particles was measured as an average particle diameter of the particles.

### (3) Method of Measuring Arithmetic Average Roughness (Sa):

The surface of the film was measured for a surface roughness thereof using a non-contact surface/layer section profile measuring system “VertScan (registered trademark) R550GML” manufactured by Ryoka Systems Inc., under the following conditions: CCD camera: “SONY HR-50 ⅓′”; objective lens: magnification: 20 times; lens barrel: “1× Body”; zoom lens: “No Relay”; wavelength filter: “530 white”; measuring mode: “Wave”, and the value outputted by correction according to a 4th-order polynomial was used as the arithmetic average roughness (Sa).

### (4) Method of Measuring Thicknesses of Adhesive Layer and Functional Layer:

The surface of the adhesive layer or functional layer was dyed with RuO₄, and the resulting film was embedded in an epoxy resin. Thereafter, the resin-embedded film was cut into a piece by an ultrathin sectioning method, and the cut piece was dyed with RuO₄ to observe and measure a cut section of the adhesive layer using TEM (“H-7650” manufactured by Hitachi High-Technologies; accelerated voltage: 100 kV).

### (5) Glass Transition Point:

Using a differential scanning calorimeter (DSC) “8500” manufactured by PerkinElmer Japan Co., Ltd., the glass transition point was measured in a temperature range of −100 to 200° C. at a temperature rise rate of 10° C./min.

### (6) Method of Measuring Number-Average Molecular Weight:

The measurement of the molecular weight was conducted using a GPC apparatus “HLC-8120GPC” manufactured by Tosoh Corp. The number-average molecular weight was calculated in terms of polystyrene.

### (7) Method of Measuring Haze:

Using a haze meter “HM-150” manufactured by Murakami Color Research Laboratory Co., Ltd., the haze was measured according to JIS K 7136.

### (8-1) Method of Evaluating Adhesion Strength (Adhesion Strength 1):

The surface of the adhesive layer of the adhesive film having a width of 5 cm according to the present invention was press-bonded onto a surface of a polymethyl methacrylate plate “COMOGLAS” (registered trademark; thickness: 1 mm) produced by KURARAY Co., Ltd., by moving a 2 kg rubber roller having a width of 5 cm thereover by one reciprocative motion. The resulting laminate was allowed to stand at room temperature for 1 hr to measure a peel force of the adhesive film required upon releasing the film from the polymethyl methacrylate plate. The measurement of the peel force was conducted by 180° peel test at an elastic stress rate of 300 mm/min using “Ezgraph” manufactured by Shimadzu Corporation.

### (8-2) Method of Evaluating Adhesion Strength (Adhesion Strength 2):

The same procedure for evaluating the adhesive strength as described in the above item (8-1) was conducted except that the polyester film having no adhesive layer (thickness: 25 μm) obtained in the below-mentioned Comparative Example 1 was used instead of the polymethyl methacrylate plate used in the item (8-1).

### (9) Method of Measuring Anti-Blocking Properties:

The two polyester films to be measured were prepared and overlapped on each other such that the adhesive layer side of one polyester film was faced to the opposite side (i.e., the side of a functional layer, if any) of the other polyester film. The area of 12 cm×10 cm of the obtained laminate was pressed at 40° C. and 80% RH under 10 kg/cm² for 20 hr. Thereafter, the films were peeled off from each other by the method as prescribed in ASTM D1893 to measure a delamination load between the films.

As the delamination load becomes smaller, the film hardly suffers from blocking and therefore has good anti-blocking properties. The delamination load is usually in the range of not more than 100 g/cm, preferably not more than 30 g/cm, more preferably not more than 20 g/cm, even more preferably not more than 10 g/cm, and most preferably not more than 8 g/cm. Meanwhile, in the case where the delamination load of the film was not measurable with sufficient accuracy because the delamination load exceeded 300 g/cm, or in the case where the film suffered from breakage, the film is expressed by the mark “-”.

### (10) Method of Evaluating Adhesiveness of Adhesive Layer to Base Material Film:

One sheet of the A4 size adhesive film was overlapped with the A4 size polyester film obtained in the below-mentioned Comparative Example 1 on which no adhesive layer was formed, such that the adhesive layer side of the adhesive film was faced and overlapped onto the latter polyester film, and the overlapped films were strongly pressed with fingers and laminated on each other. Then, the film having the adhesive layer was peeled off from the other film, and the surface of the film having no adhesive layer obtained in Comparative Example 1 was observed to evaluate adhesive residue thereon according to the following ratings.

A: No adhesive residue (no traces of transfer of the adhesive layer) was present (adhesiveness of the adhesive layer to the base material film was good); and

B: Adhesive residue was present (adhesiveness of the adhesive layer to the base material film was poor).

(11) Method of Evaluating Transparency of Adhesive Film after Attached onto Adherend:

The surface of the adhesive layer of the adhesive film having a width of 5 cm according to the present invention was overlapped onto a surface of a polymethyl methacrylate plate “COMOGLAS (registered trademark; thickness: 1 mm)” produced by KURARAY Co., Ltd., and a 2 kg rubber roller having a width of 5 cm was moved over the resulting laminate by two reciprocative motions to press-bond and attach the adhesive film onto the polymethyl methacrylate plate. The appearance of the resulting laminate after being press-bonded was visually observed from the side of the adhesive film.

The evaluation ratings are as follows.

A: The adhesive film had high transparency, and it was possible to clearly observe the polymethyl methacrylate plate from the side of the adhesive film;

B: The adhesive film had a somewhat granulated appearance, but was sufficiently transparent, and it was possible to observe the polymethyl methacrylate plate from the side of the adhesive film;

C: The adhesive film had a somewhat frosted appearance, but it was still possible to sufficiently observe the polymethyl methacrylate plate from the side of the adhesive film; and

D: The adhesive film had a frosted appearance, and it was not possible to sufficiently observe the polymethyl methacrylate plate from the side of the adhesive film.

### (12) Method of Evaluating Transfer Properties of Adhesive Layer to Adherend:

The surface of the adhesive layer of the adhesive film having a width of 5 cm according to the present invention was attached onto a surface of a polymethyl methacrylate plate “COMOGLAS (registered trademark; thickness: 1 mm)” produced by KURARAY Co., Ltd., and a 2 kg rubber roller having a width of 5 cm was moved over the resulting laminate by two reciprocative motions to press-bond and attach the adhesive film onto the polymethyl methacrylate plate. The thus bonded laminate was allowed to stand at a temperature of 60° C. for 8 days, and then the adhesive film was peeled off to observe the surface of the polymethyl methacrylate plate.

The evaluation ratings are as follows.

A: No transfer trace was present on the polymethyl methacrylate plate (no transfer of the adhesive layer thereto was observed);

B: Very thin transfer trace was observed when stared for 3 sec under a fluorescent light;

C: Thin transfer trace was observed;

D: Clear white transfer trace was partially observed at an edge of the polymethyl methacrylate plate to which the film was attached, etc. (transfer of the adhesive layer occurred); and

E: Clear white transfer trace was observed over the whole surface of the polymethyl methacrylate plate. Meanwhile, in the case where the adhesive film was not attachable onto the adherend, the transfer properties of the film was expressed by the mark “-”. In the applications in which it is necessary to take care of transfer of the adhesive layer to an adherend to some extent, the use of the adhesive film having evaluation ratings D or E should be avoided. In the applications in which particularly less transfer of the adhesive layer to an adherend was required, the use of the adhesive film having evaluation ratings A or B is preferred, and the use of the adhesive film having evaluation rating A is more preferred.

### (13) Method of Measuring Surface Resistance:

Using a high resistance meter “HP4339B” and a measuring electrode “HP16008B” both manufactured by Hewlett Packard Japan Ltd., after the polyester film was fully moisture-controlled in a measuring atmosphere of 23° C. and 50% RH, a voltage of 100 V was applied to the film for 1 min, and then the surface resistance of an antistatic layer of the film was measured.

(14) Method of Evaluating Deposition of Dirt and Dusts onto Functional Layer (Antistatic Layer) Side:

The polyester film was fully moisture-controlled in a measuring atmosphere of 23° C. and 50% RH, and then the antistatic layer of the film was rubbed with cotton cloth by 10 reciprocative motions. The thus rubbed antistatic layer of the film was slowly approached to finely crushed tobacco ash to evaluate adhesion of the ash thereonto according to the following evaluation ratings.

A: No adhesion of ash onto the film occurred even when contacted with the ash;

B: Slight adhesion of ash onto the film occurred when contacted with the ash; and

C: A large amount of ash was adhered onto the film even when merely approached to the ash.

The polyesters used in the respective Examples and Comparative Examples were prepared by the following methods.

### <Method of Producing Polyester (A)>

One hundred parts by weight of dimethyl terephthalate and 60 parts by weight of ethylene glycol as well as ethyl acid phosphate and magnesium acetate tetrahydrate as a catalyst in amounts of 30 ppm and 100 ppm, respectively, based on the polyester as produced, were subjected to esterification reaction at 260° C. in a nitrogen atmosphere. Successively, tetrabutyl titanate in an amount of 50 ppm based on the polyester as produced was added to the reaction solution. While heating the resulting mixture to 280° C. over 2 hr and 30 min, the pressure of the reaction system was reduced to an absolute pressure of 0.3 kPa, and further the mixture was subjected to melt-polycondensation for 80 min, thereby obtaining a polyester (A) having an intrinsic viscosity of 0.63 and a diethylene glycol content of 2 mol %.

### <Method of Producing Polyester (B)>

One hundred parts by weight of dimethyl terephthalate and 60 parts by weight of ethylene glycol as well as magnesium acetate tetrahydrate as a catalyst in an amount of 900 ppm based on the polyester as produced, were subjected to esterification reaction at 225° C. in a nitrogen atmosphere. Successively, orthophosphoric acid and germanium dioxide in amounts of 3500 ppm and 70 ppm, respectively, based on the polyester as produced, were added to the reaction solution. While heating the resulting mixture to 280° C. over 2 hr and 30 min, the pressure of the reaction system was reduced to an absolute pressure of 0.4 kPa, and further the mixture was subjected to melt-polycondensation for 85 min, thereby obtaining a polyester (B) having an intrinsic viscosity of 0.64 and a diethylene glycol content of 2 mol %.

### <Method of Producing Polyester (C)>

The same procedure as used in the above method of producing the polyester (A) was conducted except that silica particles having an average particle diameter of 2 μm were added in an amount of 0.3 part by weight before the melt-polycondensation, thereby obtaining a polyester (C).

### <Method of Producing Polyester (D)>

The same procedure as used in the above method of producing the polyester (A) was conducted except that silica particles having an average particle diameter of 3.2 μm were added in an amount of 0.6 part by weight before the melt-polycondensation, thereby obtaining a polyester (D).

Examples of compounds constituting the adhesive layer and the functional layer are as follows.

### (Examples of Compounds)

(Meth)Acrylic Resin: (IA)

Water dispersion of an acrylic resin (glass transition point: −50° C.) obtained from the following composition:

2-Ethylhexyl acrylate/methyl methacrylate/methacrylic acid=85/12/3 (% by weight).

(Meth)Acrylic Resin: (IB)

Water dispersion of an acrylic resin (glass transition point: −55° C.) obtained from the following composition:

2-Ethylhexyl acrylate/n-butyl acrylate/methyl methacrylate/2-hydroxyethyl methacrylate=77/10/5/8 (% by weight).

(Meth)Acrylic Resin: (IC)

Water dispersion of an acrylic resin (glass transition point: −25° C.) obtained from the following composition:

Normal-butyl acrylate/styrene/acrylic acid=62/35/3 (% by weight).

(Meth)Acrylic Resin: (ID)

Water dispersion of an acrylic resin (glass transition point: −40° C.) obtained from the following composition:

2-Ethylhexyl acrylate/n-butyl acrylate/methyl methacrylate/2-hydroxyethyl methacrylate/acrylic acid=58/20/15/5/2 (% by weight).

(Meth)Acrylic Resin: (Ie)

Water dispersion of an acrylic resin (glass transition point: −40° C.) obtained from the following composition:

Normal-butyl acrylate/2-ethylhexyl acrylate/acrylonitrile/acrylic acid=82/10/5/3 (% by weight).

(Meth)Acrylic Resin: (IF)

Water dispersion of an acrylic resin (glass transition point: −50° C.) obtained from the following composition:

2-Ethylhexyl acrylate/n-butyl acrylate/ethyl acrylate/2-hydroxyethyl methacrylate/acrylic acid=50/27/15/5/3 (% by weight).

(Meth)Acrylic Resin: (IG)

Water dispersion of an acrylic resin (glass transition point: 10° C.) obtained from the following composition:

Normal-butyl acrylate/ethyl acrylate/methyl methacrylate/2-hydroxyethyl methacrylate/acrylic acid=10/52/30/5/3 (% by weight).

(Meth)Acrylic Resin: (IH)

Water dispersion of an acrylic resin (glass transition point: 40° C.) obtained from the following composition:

Ethyl acrylate/methyl methacrylate/N-methylol acrylamide/acrylic acid=48/45/4/3 (% by weight).

Melamine Compound: (IIA)

Hexamethoxymethylol melamine

Isocyanate-Based Compound: (IIB)

While stirring 1000 parts of hexamethylene diisocyanate at 60° C., 0.1 part of tetramethyl ammonium caprylate as a catalyst was added thereto. After the elapse of 4 hr, 0.2 part of phosphoric acid was added to the obtained reaction mixture to terminate the reaction, thereby obtaining an isocyanurate-type polyisocyanate composition. Then, 100 parts of the thus obtained isocyanurate-type polyisocyanate composition, 42.3 parts of methoxy polyethylene glycol having a number-average molecular weight of 400 and 29.5 parts of propylene glycol monomethyl ether acetate were charged to a reaction vessel, and held at 80° C. for 7 hr. Thereafter, while maintaining the temperature of the reaction solution at 60° C., 35.8 parts of methyl isobutanoyl acetate, 32.2 parts of diethyl malonate and 0.88 part of a 28% methanol solution of sodium methoxide were added to the reaction solution, and the resulting reaction mixture was allowed to stand for 4 hr. Then, 58.9 parts of n-butanol was added to the reaction mixture, and the obtained reaction solution was maintained at 80° C. for 2 hr. Thereafter, 0.86 part of 2-ethylhexyl acid phosphate was added to the reaction solution, thereby obtaining an active methylene-blocked polyisocyanate.

Oxazoline Compound: (IIC)

Acrylic polymer having an oxazoline group and a polyalkyleneoxide chain “EPOCROSS” (oxazoline group content: 4.5 mmol/g) produced by Nippon Shokubai Co., Ltd.

Epoxy Compound: (IID)

Polyglycerol polyglycidyl ether as a polyfunctional polyepoxy compound.

Polyester Resin: (IIIA)

Water dispersion of a polyester resin (glass transition point: −20° C.) obtained from the following composition:

Monomer composition: (acid component) dodecanedicarboxylic acid/terephthalic acid/isophthalic acid/5-sodium sulfoisophthalic acid//(diol component) ethylene glycol/1,4-butanediol=20/38/38/4//40/60 (mol %).

Polyester Resin: (IIIB)

Water dispersion of a polyester resin (glass transition point: 50° C.) obtained from the following composition:

Monomer composition: (acid component) terephthalic acid/isophthalic acid/5-sodium sulfoisophthalic acid//(diol component) ethylene glycol/1,4-butanediol/diethylene glycol=50/46/4//70/20/10 (mol %).

Urethane Resin: (IIIC)

Water dispersion of a urethane resin (glass transition point: −30° C.) obtained from the following composition:

Polycarbonate polyol having a number-average molecular weight of 2000 which was produced from 1,6-hexanediol and diethyl carbonate/polyethylene glycol having a number-average molecular weight of 400/methylene-bis(4-cyclohexyl isocyanate)/dimethylol butanoic acid=80/4/12/4 (% by weight).

Urethane Resin: (IIID)

Water dispersion of a urethane resin (glass transition point: 50° C.) obtained from the following composition:

Isophorone diisocyanate/terephthalic acid/isophthalic acid/ethylene glycol/diethylene glycol/dimethylol propionic acid=12/19/18/21/25/5 (mol %).

Particles: (IV)

Silica particles having an average particle diameter of 45 nm.

Release Agent (Long-Chain Alkyl Group-Containing Compound): (VA)

A four-necked flask was charged with 200 parts of xylene and 600 parts of octadecyl isocyanate, and the contents of the flask were heated while stirring. From the time at which refluxing of xylene was initiated, 100 parts of polyvinyl alcohol having an average polymerization degree of 500 and a saponification degree of 88 mol % was added little by little to the flask at intervals of 10 min over about 2 hr. After completion of the addition of polyvinyl alcohol, the contents of the flask were further refluxed for 2 hr, and then the reaction thereof was terminated. The obtained reaction mixture was cooled to about 80° C., and then added to methanol, thereby obtaining a white precipitate as a reaction product. The resulting precipitate was separated from the reaction mixture by filtration, and 140 parts of xylene was added thereto. The obtained mixture was heated to completely dissolve the precipitate in xylene, and then methanol was added again thereto to obtain a precipitate. The precipitation procedure was repeated several times. Thereafter, the thus obtained precipitates were washed with methanol, and then dried and pulverized, thereby obtaining the release agent.

Release Agent (Fluorine Compound): (VB)

Water dispersion of a fluorine compound obtained from the following composition:

Octadecyl acrylate/perfluorohexylethyl methacrylate/vinyl chloride=66/17/17 (% by weight).

Polyether Group-Containing Condensation-Type Silicone: (VC)

Polyether group-containing silicone having a number-average molecular weight of 7000 and comprising polyethylene glycol (end group: hydroxyl group) having a number of ethylene glycol chains of 8 in which a molar ratio of polyethylene glycol to dimethyl siloxane was 1:100, on a side chain of the dimethyl silicone (assuming that a molar amount of a siloxane bond in the silicone is 1, a molar ratio of an ether bond in the polyether group to the siloxane bond is 0.07). In the polyether group-containing condensation type silicone, low molecular weight components having a number-average molecular weight of not more than 500 were present in an amount of 3%, and neither a vinyl group bonded to silicon (vinyl silane) nor a hydrogen group bonded to silicon (hydrogen silane) was present. Meanwhile, the present compound was used in the form of a water dispersion of the composition prepared by blending the polyether group-containing silicone with sodium dodecylbenzenesulfonate at a weight ratio of 1:0.25.

Wax: (VD)

Wax emulsion prepared by charging 300 g of a polyethyleneoxide wax having a melting point of 105° C., an acid value of 16 mgKOH/g, a density of 0.93 g/mL and a number-average molecular weight of 5000, 650 g of ion-exchanged water, 50 g of decaglycerol monooleate as a surfactant and 10 g of a 48% potassium hydroxide aqueous solution into a 1.5 L-capacity emulsification facility equipped with a stirrer, a thermometer and a temperature controller, followed by replacing an inside atmosphere of the facility with nitrogen and then hermetically sealing the facility; subjecting the contents of the facility to high-speed stirring at 150° C. for 1 hr and then cooling the contents of the facility to 130° C.; and allowing the resulting reaction mixture to pass through a high-pressure homogenizer under a pressure of 400 atm and then cooling the obtained mixture to 40° C.

Antistatic Agent (Quaternary Ammonium Salt Compound): (VIA)

Polymer having a pyrrolidinium ring in a main chain thereof which was prepared by polymerizing the following composition:

Diallyl dimethyl ammonium chloride/dimethyl acrylamide/N-methylol acrylamide=90/5/5 (mol %). Number-average molecular weight: 30000.

Antistatic Agent (Ammonium Group-Containing Compound): (VIB)

High-molecular weight compound having a number-average molecular weight of 50000 and comprising a constitutional unit represented by the following formula (2) in which a counter ion is a methanesulfonic acid ion.

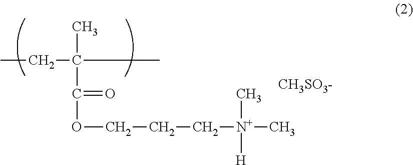

### Example 1

A mixed raw material obtained by mixing the polyesters (A), (B) and (C) in amounts of 91% by weight, 3% by weight and 6% by weight, respectively, as a raw material for outermost layers (surface layers), and a mixed raw material obtained by mixing the polyesters (A) and (B) in amounts of 97% by weight and 3% by weight, respectively, as a raw material for an intermediate layer, were respectively charged into two extruders, melted therein at 285° C., and then co-extruded therefrom on a chilled roll whose surface was controlled to a temperature of 40° C. into a two-kind/three-layer structure (surface layer/intermediate layer/surface layer=3:19:3 as output), followed by cooling and solidifying the thus extruded sheet on the chilled roll, thereby obtaining an undrawn sheet.

Next, the thus obtained undrawn sheet was drawn utilizing a difference between peripheral speeds of rolls at 85° C. at a draw ratio of 3.3 times in a longitudinal direction thereof. Thereafter, a coating solution A1 shown in Table 1 below was applied onto one side surface of the thus obtained longitudinally drawn film such that the thickness of the resulting adhesive layer (after drying) was 120 nm, and a coating solution B1 shown in Table 2 below was applied onto an opposite side surface of the longitudinally drawn film such that the thickness of the resulting functional layer (after drying) was 30 nm. Then, the resulting coated film was introduced into a tenter where the film was dried at 90° C. for 10 sec and then drawn at 110° C. at a draw ratio of 4.3 times in a lateral direction thereof, and the obtained film was further subjected to heat-setting treatment at 230° C. for 10 sec. Next, the thus obtained drawn film was relaxed by 2% in a lateral direction thereof, thereby obtaining a polyester film having a thickness of 25 μm and Sa of 9 nm as measured on the opposite surfaces of the film, i.e., both on the side of the adhesive layer and on the rear side opposed to the adhesive layer (the surface on the side of the functional layer). Meanwhile, when the adhesive layer was removed by treating the layer with ethyl acetate, the Sa value of the surface of the polyester film from which the adhesive layer had been removed was 9 nm.

As a result of evaluating the thus obtained polyester film, it was confirmed that the polyester film had an adhesion strength to a polymethyl methacrylate plate of 16 mN/cm and therefore could exhibit not only good adhesion properties but also good adhesiveness to the base material film. Various properties of the thus obtained film are shown in Table 3 below.

### Examples 2 to 129

The same procedure as in Example 1 was conducted except that the coating agent composition was changed to those shown in Tables 1 and 2, thereby obtaining polyester films. As shown in Tables 3 to 8, the resulting polyester films were excellent in not only adhesion strength but also adhesiveness to the base material film.

### Example 130

A mixed raw material obtained by mixing the polyesters (A), (B) and (D) in amounts of 87% by weight, 3% by weight and 10% by weight, respectively, as a raw material for outermost layers (surface layers), and a mixed raw material obtained by mixing the polyesters (A) and (B) in amounts of 97% by weight and 3% by weight, respectively, as a raw material for an intermediate layer, were respectively charged into two extruders, melted therein at 285° C., and then co-extruded therefrom on a chilled roll whose surface was controlled to a temperature of 40° C. into a two-kind/three-layer structure (surface layer/intermediate layer/surface layer=6:13:6 as output), followed by cooling and solidifying the thus extruded sheet on the chilled roll, thereby obtaining an undrawn sheet. Next, the thus obtained undrawn sheet was drawn utilizing a difference between peripheral speeds of rolls at 85° C. at a draw ratio of 3.3 times in a longitudinal direction thereof. Thereafter, a coating solution A1 shown in Table 1 below was applied onto one side surface of the thus obtained longitudinally drawn film such that the thickness of the resulting adhesive layer (after drying) was 150 nm, and a coating solution B1 shown in Table 2 below was applied onto an opposite side surface of the longitudinally drawn film such that the thickness of the resulting functional layer (after drying) was 30 nm. Then, the resulting coated film was introduced into a tenter where the film was dried at 90° C. for 10 sec and then drawn at 110° C. at a draw ratio of 4.3 times in a lateral direction thereof, and the obtained film was further subjected to heat-setting treatment at 230° C. for 10 sec. Next, the obtained drawn film was relaxed by 2% in a lateral direction thereof, thereby obtaining a polyester film having a thickness of 25 μm and Sa of 15 nm as measured on the surface on the side of the adhesive layer and on the rear side surface of the film opposed to the adhesive layer (the surface on the side of the functional layer). Meanwhile, when the adhesive layer was removed by treating the layer with ethyl acetate, the Sa value of the surface of the polyester film from which the adhesive layer had been removed was 15 nm.

As a result of evaluating the thus obtained polyester film, it was confirmed that the polyester film had an adhesion strength of 20 mN/cm as measured by adhering to a polymethyl methacrylate plate and therefore could exhibit not only good adhesion strength but also good adhesiveness to the base material film. Various properties of the thus obtained film are shown in Table 8 below.

### Example 131

The same procedure as in Example 130 was conducted except that no functional layer was formed, thereby obtaining a polyester film. As shown in Table 8, the resulting polyester film was excellent in not only adhesion strength but also adhesiveness to the base material film.

### Example 132

A mixed raw material obtained by mixing the polyesters (A), (B) and (C) in amounts of 91% by weight, 3% by weight and 6% by weight, respectively, as a raw material for an outermost layer (surface layer 1), a mixed raw material obtained by mixing the polyesters (A), (B) and (D) in amounts of 82% by weight, 3% by weight and 15% by weight, respectively, as a raw material for another outermost layer (surface layer 2), and a mixed raw material obtained by mixing the polyesters (A) and (B) in amounts of 97% by weight and 3% by weight, respectively, as a raw material for an intermediate layer, were respectively charged into two extruders, melted therein at 285° C., and then co-extruded therefrom on a chilled roll whose surface was controlled to a temperature of 40° C. into a three-kind/three-layer structure (surface layer 1/intermediate layer/surface layer 2=6:13:6 as output), followed by cooling and solidifying the thus extruded sheet on the chilled roll, thereby obtaining an undrawn sheet. Next, the thus obtained undrawn sheet was drawn utilizing a difference between peripheral speeds of rolls at 85° C. at a draw ratio of 3.3 times in a longitudinal direction thereof. Thereafter, a coating solution A1 shown in Table 1 below was applied onto the surface on the side of the surface layer 1 of the thus obtained longitudinally drawn film such that the thickness of the resulting adhesive layer (after drying) was 150 nm, and a coating solution B1 shown in Table 2 below was applied onto an opposite side surface of the longitudinally drawn film such that the thickness of the resulting functional layer (after drying) was 30 nm. Then, the resulting coated film was introduced into a tenter where the film was dried at 90° C. for 10 sec and then drawn at 110° C. at a draw ratio of 4.3 times in a lateral direction thereof, and the obtained film was further subjected to heat-setting treatment at 230° C. for 10 sec. Next, the obtained drawn film was relaxed by 2% in a lateral direction thereof, thereby obtaining a polyester film having a thickness of 25 μm, Sa of 9 nm as measured on the surface on the side of the adhesive layer, and Sa of 20 nm as measured on the rear side surface of the film opposed to the adhesive layer (the surface on the side of the surface layer 2, i.e., the surface on the side of the functional layer). Meanwhile, when the adhesive layer was removed by treating the layer with ethyl acetate, the Sa value of the surface of the polyester film from which the adhesive layer had been removed was 9 nm.

As a result of evaluating the thus obtained polyester film, it was confirmed that the polyester film had an adhesion strength of 22 mN/cm as measured by adhering to a polymethyl methacrylate plate and therefore could exhibit not only good adhesion strength but also good adhesiveness to the base material film. Various properties of the thus obtained film are shown in Table 8 below.

### Example 133

The same procedure as in Example 132 was conducted except that no functional layer was formed, thereby obtaining a polyester film. As shown in Table 8, the resulting polyester film was excellent in not only adhesion strength but also adhesiveness to the base material film.

### Example 134

A mixed raw material obtained by mixing the polyesters (A), (B) and (C) in amounts of 91% by weight, 3% by weight and 6% by weight, respectively, as a raw material for an outermost layer (surface layer 1), a mixed raw material obtained by mixing the polyesters (A), (B) and (D) in amounts of 72% by weight, 3% by weight and 25% by weight, respectively, as a raw material for another outermost layer (surface layer 2), and a mixed raw material obtained by mixing the polyesters (A) and (B) in amounts of 97% by weight and 3% by weight, respectively, as a raw material for an intermediate layer, were respectively charged into two extruders, melted therein at 285° C., and then co-extruded therefrom on a chilled roll whose surface was controlled to a temperature of 40° C. into a three-kind/three-layer structure (surface layer 1/intermediate layer/surface layer 2=6:13:6 as output), followed by cooling and solidifying the thus extruded sheet on the chilled roll, thereby obtaining an undrawn sheet. Next, the thus obtained undrawn sheet was drawn utilizing a difference between peripheral speeds of rolls at 85° C. at a draw ratio of 3.3 times in a longitudinal direction thereof. Thereafter, a coating solution A1 shown in Table 1 below was applied onto the surface on the side of the surface layer 1 of the thus obtained longitudinally drawn film such that the thickness of the resulting adhesive layer (after drying) was 150 nm, and a coating solution B1 shown in Table 2 below was applied onto an opposite side surface of the longitudinally drawn film such that the thickness of the resulting functional layer (after drying) was 30 nm. Then, the resulting coated film was introduced into a tenter where the film was dried at 90° C. for 10 sec and then drawn at 110° C. at a draw ratio of 4.3 times in a lateral direction thereof, and the obtained film was further subjected to heat-setting treatment at 230° C. for 10 sec. Next, the obtained drawn film was relaxed by 2% in a lateral direction thereof, thereby obtaining a polyester film having a thickness of 25 Sa of 9 nm as measured on the surface on the side of the adhesive layer, and Sa of 30 nm as measured on the rear side surface of the film opposed to the adhesive layer (the surface on the side of the surface layer 2, i.e., the surface on the side of the functional layer). Meanwhile, when the adhesive layer was removed by treating the layer with ethyl acetate, the Sa value of the surface of the polyester film from which the adhesive layer had been removed was 9 nm.

As a result of evaluating the thus obtained polyester film, it was confirmed that the polyester film had an adhesion strength of 22 mN/cm as measured by adhering to a polymethyl methacrylate plate and therefore could exhibit not only good adhesion strength but also good adhesiveness to the base material film. Various properties of the thus obtained film are shown in Table 8 below.

### Example 135

The same procedure as in Example 134 was conducted except that no functional layer was formed, thereby obtaining a polyester film. As shown in Table 8, the resulting polyester film was excellent in not only adhesion strength but also adhesiveness to the base material film.

### Example 136

A mixed raw material obtained by mixing the polyesters (A), (B) and (C) in amounts of 91% by weight, 3% by weight and 6% by weight, respectively, as a raw material for an outermost layer (surface layer 1), a mixed raw material obtained by mixing the polyesters (A), (B) and (D) in amounts of 47% by weight, 3% by weight and 50% by weight, respectively, as a raw material for another outermost layer (surface layer 2), and a mixed raw material obtained by mixing the polyesters (A) and (B) in amounts of 97% by weight and 3% by weight, respectively, as a raw material for an intermediate layer, were respectively charged into two extruders, melted therein at 285° C., and then co-extruded therefrom on a chilled roll whose surface was controlled to a temperature of 40° C. into a three-kind/three-layer structure (surface layer 1/intermediate layer/surface layer 2=4:17:4 as output), followed by cooling and solidifying the thus extruded sheet on the chilled roll, thereby obtaining an undrawn sheet. Next, the thus obtained undrawn sheet was drawn utilizing a difference between peripheral speeds of rolls at 85° C. at a draw ratio of 3.3 times in a longitudinal direction thereof. Thereafter, a coating solution A1 shown in Table 1 below was applied onto the surface on the side of the surface layer 1 of the thus obtained longitudinally drawn film such that the thickness of the resulting adhesive layer (after drying) was 150 nm. Then, the resulting coating film was introduced into a tenter where the film was dried at 90° C. for 10 sec and then drawn at 110° C. at a draw ratio of 4.3 times in a lateral direction thereof, and the obtained film was further subjected to heat-setting treatment at 230° C. for 10 sec. Next, the obtained drawn film was relaxed by 2% in a lateral direction thereof, thereby obtaining a polyester film having a thickness of 25 μm, Sa of 9 nm as measured on the surface on the side of the adhesive layer, and Sa of 55 nm as measured on the rear side surface of the film opposed to the adhesive layer.

Meanwhile, when the adhesive layer was removed by treating the layer with ethyl acetate, the Sa value of the surface of the polyester film from which the adhesive layer had been removed was 9 nm.

As a result of evaluating the thus obtained polyester film, it was confirmed that the polyester film had an adhesion strength of 22 mN/cm as measured by adhering to a polymethyl methacrylate plate and therefore could exhibit not only good adhesion properties but also good adhesiveness to the base material film. Various properties of the thus obtained film are shown in Table 8 below.

### Example 137

The same procedure as in Example 1 was conducted except that no adhesive layer was formed, thereby obtaining a polyester film. The thus obtained polyester film having no adhesive layer was coated with a coating solution A9 shown in Table 1 below such that the thickness of the resulting adhesive layer was 150 nm (after drying), and then dried at 100° C. for 60 sec, thereby obtaining the polyester film on which the adhesive layer was formed and laminated by an off-line coating method. As shown in Table 8, the resulting polyester film was excellent in adhesion strength. However, the resulting polyester film had poor adhesiveness to the base material film, and exhibited significant transfer of the adhesive layer to an adherend.

### Example 138

The same procedure as in Example 1 was conducted except that no adhesive layer was formed, thereby obtaining a polyester film. The thus obtained polyester film having no adhesive layer was coated with a coating solution A9 shown in Table 1 below such that the thickness of the resulting adhesive layer was 20 μm (after drying), and then dried at 100° C. for 120 sec, thereby obtaining the polyester film on which the adhesive layer was formed and laminated by an off-line coating method. The adhesion strength of the resulting polyester film was not accurately measurable, but the polyester film had an adhesion strength of not less than 1 mN/cm. However, when the resulting film was adhered onto a polyester film such that the adhesive layer of the film was contacted with the polyester film, and then cut, there occurred squeeze-out of components of the adhesive layer which was never observed in the respective Examples, so that a fear of contamination of an adherend with the adhesive component was caused. The other properties of the film are shown in Table 9.

### Comparative Example 1

The same procedure as in Example 1 was conducted except that neither the adhesive layer nor the functional layer was provided, thereby obtaining a polyester film. As a result of evaluating the resulting polyester film, it was confirmed that as shown in Table 9 below, the film had no adhesion strength.

### Comparative Examples 2 to 6

The same procedure as in Example 1 was conducted except that the coating agent composition was replaced with those shown in Table 1, thereby obtaining polyester films. As shown in Table 9, the resulting polyester films had no adhesion strength.

TABLE 1

| | |
|---|---|
| | Coating agent composition (wt %) |
| Coating | based on nonvolatile components |

| solution | IA | IB | IC | ID | IE | IF |
|---|---|---|---|---|---|---|
| A1 | 90 | 0 | 0 | 0 | 0 | 0 |
| A2 | 87 | 0 | 0 | 0 | 0 | 0 |
| A3 | 95 | 0 | 0 | 0 | 0 | 0 |
| A4 | 80 | 0 | 0 | 0 | 0 | 0 |
| A5 | 90 | 0 | 0 | 0 | 0 | 0 |
| A6 | 80 | 0 | 0 | 0 | 0 | 0 |
| A7 | 90 | 0 | 0 | 0 | 0 | 0 |
| A8 | 90 | 0 | 0 | 0 | 0 | 0 |
| A9 | 100 | 0 | 0 | 0 | 0 | 0 |
| A10 | 97 | 0 | 0 | 0 | 0 | 0 |
| A11 | 90 | 0 | 0 | 0 | 0 | 0 |
| A12 | 90 | 0 | 0 | 0 | 0 | 0 |
| A13 | 90 | 0 | 0 | 0 | 0 | 0 |
| A14 | 90 | 0 | 0 | 0 | 0 | 0 |
| A15 | 90 | 0 | 0 | 0 | 0 | 0 |
| A16 | 0 | 90 | 0 | 0 | 0 | 0 |
| A17 | 0 | 100 | 0 | 0 | 0 | 0 |
| A18 | 0 | 0 | 90 | 0 | 0 | 0 |
| A19 | 0 | 0 | 89 | 0 | 0 | 0 |
| A20 | 0 | 0 | 95 | 0 | 0 | 0 |
| A21 | 0 | 0 | 100 | 0 | 0 | 0 |
| A22 | 0 | 0 | 99 | 0 | 0 | 0 |
| A23 | 0 | 0 | 0 | 85 | 0 | 0 |
| A24 | 0 | 0 | 0 | 90 | 0 | 0 |
| A25 | 0 | 0 | 0 | 88 | 0 | 0 |
| A26 | 0 | 0 | 0 | 95 | 0 | 0 |
| A27 | 0 | 0 | 0 | 100 | 0 | 0 |
| A28 | 0 | 0 | 0 | 0 | 90 | 0 |
| A29 | 0 | 0 | 0 | 0 | 0 | 90 |
| A30 | 0 | 0 | 0 | 0 | 0 | 95 |
| C1 | 0 | 0 | 0 | 0 | 0 | 0 |
| C2 | 0 | 0 | 0 | 0 | 0 | 0 |
| C3 | 0 | 0 | 0 | 0 | 0 | 0 |
| C4 | 0 | 0 | 0 | 0 | 0 | 0 |
| C5 | 0 | 0 | 0 | 0 | 0 | 0 |

| | |
|---|---|
| | Coating agent composition (wt %) |
| Coating | based on nonvolatile components |

| solution | IG | IH | IIA | IIB | IIC | IID |
|---|---|---|---|---|---|---|
| A1 | 0 | 0 | 10 | 0 | 0 | 0 |
| A2 | 0 | 0 | 10 | 0 | 0 | 0 |
| A3 | 0 | 0 | 5 | 0 | 0 | 0 |
| A4 | 0 | 0 | 20 | 0 | 0 | 0 |
| A5 | 0 | 0 | 0 | 10 | 0 | 0 |
| A6 | 0 | 0 | 0 | 20 | 0 | 0 |
| A7 | 0 | 0 | 0 | 0 | 10 | 0 |
| A8 | 0 | 0 | 0 | 0 | 0 | 10 |
| A9 | 0 | 0 | 0 | 0 | 0 | 0 |
| A10 | 0 | 0 | 0 | 0 | 0 | 0 |
| A11 | 0 | 10 | 0 | 0 | 0 | 0 |
| A12 | 0 | 0 | 0 | 0 | 0 | 0 |
| A13 | 0 | 0 | 0 | 0 | 0 | 0 |
| A14 | 0 | 0 | 0 | 0 | 0 | 0 |
| A15 | 0 | 0 | 0 | 0 | 0 | 0 |
| A16 | 0 | 0 | 10 | 0 | 0 | 0 |
| A17 | 0 | 0 | 0 | 0 | 0 | 0 |
| A18 | 0 | 0 | 10 | 0 | 0 | 0 |
| A19 | 0 | 0 | 10 | 0 | 0 | 0 |
| A20 | 0 | 0 | 5 | 0 | 0 | 0 |
| A21 | 0 | 0 | 0 | 0 | 0 | 0 |
| A22 | 0 | 0 | 0 | 0 | 0 | 0 |
| A23 | 0 | 0 | 15 | 0 | 0 | 0 |
| A24 | 0 | 0 | 10 | 0 | 0 | 0 |
| A25 | 0 | 0 | 10 | 0 | 0 | 0 |
| A26 | 0 | 0 | 5 | 0 | 0 | 0 |
| A27 | 0 | 0 | 0 | 0 | 0 | 0 |
| A28 | 0 | 0 | 10 | 0 | 0 | 0 |
| A29 | 0 | 0 | 10 | 0 | 0 | 0 |
| A30 | 0 | 0 | 5 | 0 | 0 | 0 |
| C1 | 100 | 0 | 0 | 0 | 0 | 0 |
| C2 | 90 | 0 | 10 | 0 | 0 | 0 |
| C3 | 88 | 0 | 10 | 0 | 0 | 0 |
| C4 | 0 | 100 | 0 | 0 | 0 | 0 |
| C5 | 0 | 90 | 10 | 0 | 0 | 0 |

| | Coating agent composition (wt %) | | | | |
|---|---|---|---|---|---|
| Coating | based on nonvolatile components | | | | |
| solution | IIIA | IIIB | IIIC | IIID | IV |
| A1 | 0 | 0 | 0 | 0 | 0 |
| A2 | 0 | 0 | 0 | 0 | 3 |
| A3 | 0 | 0 | 0 | 0 | 0 |
| A4 | 0 | 0 | 0 | 0 | 0 |
| A5 | 0 | 0 | 0 | 0 | 0 |
| A6 | 0 | 0 | 0 | 0 | 0 |
| A7 | 0 | 0 | 0 | 0 | 0 |
| A8 | 0 | 0 | 0 | 0 | 0 |
| A9 | 0 | 0 | 0 | 0 | 0 |
| A10 | 0 | 0 | 0 | 0 | 3 |
| A11 | 0 | 0 | 0 | 0 | 0 |
| A12 | 10 | 0 | 0 | 0 | 0 |
| A13 | 0 | 10 | 0 | 0 | 0 |
| A14 | 0 | 0 | 10 | 0 | 0 |
| A15 | 0 | 0 | 0 | 10 | 0 |
| A16 | 0 | 0 | 0 | 0 | 0 |
| A17 | 0 | 0 | 0 | 0 | 0 |
| A18 | 0 | 0 | 0 | 0 | 0 |
| A19 | 0 | 0 | 0 | 0 | 1 |
| A20 | 0 | 0 | 0 | 0 | 0 |
| A21 | 0 | 0 | 0 | 0 | 0 |
| A22 | 0 | 0 | 0 | 0 | 1 |
| A23 | 0 | 0 | 0 | 0 | 0 |
| A24 | 0 | 0 | 0 | 0 | 0 |
| A25 | 0 | 0 | 0 | 0 | 2 |
| A26 | 0 | 0 | 0 | 0 | 0 |
| A27 | 0 | 0 | 0 | 0 | 0 |
| A28 | 0 | 0 | 0 | 0 | 0 |
| A29 | 0 | 0 | 0 | 0 | 0 |
| A30 | 0 | 0 | 0 | 0 | 0 |
| C1 | 0 | 0 | 0 | 0 | 0 |
| C2 | 0 | 0 | 0 | 0 | 0 |
| C3 | 0 | 0 | 0 | 0 | 2 |
| C4 | 0 | 0 | 0 | 0 | 0 |
| C5 | 0 | 0 | 0 | 0 | 0 |

TABLE 2

| | Coating agent composition (wt %) | | | | | | | | |
|---|---|---|---|---|---|---|---|---|---|
| Coating | based on nonvolatile components | | | | | | | | |
| solution | VA | VB | VC | VD | IH | IIIB | IIA | VIA | VIB |
| B1 | 30 | 0 | 0 | 0 | 0 | 0 | 70 | 0 | 0 |
| B2 | 65 | 0 | 0 | 0 | 0 | 0 | 35 | 0 | 0 |
| B3 | 85 | 0 | 0 | 0 | 0 | 0 | 15 | 0 | 0 |
| B4 | 15 | 0 | 0 | 0 | 0 | 45 | 40 | 0 | 0 |
| B5 | 0 | 85 | 0 | 0 | 0 | 0 | 15 | 0 | 0 |
| B6 | 0 | 0 | 20 | 0 | 0 | 45 | 35 | 0 | 0 |
| B7 | 0 | 0 | 0 | 35 | 0 | 30 | 35 | 0 | 0 |
| B8 | 0 | 0 | 35 | 0 | 0 | 0 | 25 | 40 | 0 |
| B9 | 25 | 0 | 0 | 0 | 20 | 0 | 25 | 30 | 0 |
| B10 | 30 | 0 | 0 | 0 | 10 | 0 | 20 | 0 | 40 |
| C6 | 0 | 0 | 0 | 0 | 0 | 70 | 30 | 0 | 0 |

TABLE 3

| | |
|---|---|
| Adhesive layer | Functional layer |

| | Coating | Thickness | Coating | Thickness |
|---|---|---|---|---|
| Examples | solution | (nm) | solution | (nm) |
| Example 1 | A1 | 120 | B1 | 30 |
| Example 2 | A1 | 150 | B1 | 30 |
| Example 3 | A1 | 90 | B1 | 30 |
| Example 4 | A2 | 120 | B1 | 30 |
| Example 5 | A3 | 150 | B1 | 30 |
| Example 6 | A4 | 120 | B1 | 30 |
| Example 7 | A5 | 150 | B1 | 30 |
| Example 8 | A6 | 120 | B1 | 30 |
| Example 9 | A7 | 150 | B1 | 30 |
| Example 10 | A8 | 150 | B1 | 30 |
| Example 11 | A9 | 60 | B1 | 30 |
| Example 12 | A9 | 150 | B1 | 30 |
| Example 13 | A10 | 120 | B1 | 30 |
| Example 14 | A11 | 150 | B1 | 30 |
| Example 15 | A12 | 150 | B1 | 30 |
| Example 16 | A13 | 150 | B1 | 30 |
| Example 17 | A14 | 150 | B1 | 30 |
| Example 18 | A15 | 150 | B1 | 30 |
| Example 19 | A16 | 150 | B1 | 30 |
| Example 20 | A17 | 150 | B1 | 30 |
| Example 21 | A18 | 150 | B1 | 30 |
| Example 22 | A18 | 200 | B1 | 30 |
| Example 23 | A18 | 350 | B1 | 30 |
| Example 24 | A19 | 200 | B1 | 30 |
| Example 25 | A20 | 100 | B1 | 30 |
| Example 26 | A20 | 150 | B1 | 30 |
| Example 27 | A21 | 150 | B1 | 30 |
| Example 28 | A22 | 150 | B1 | 30 |
| Example 29 | A23 | 120 | B1 | 30 |
| Example 30 | A24 | 120 | B1 | 30 |
| Example 31 | A25 | 150 | B1 | 30 |
| Example 32 | A25 | 200 | B1 | 30 |
| Example 33 | A26 | 90 | B1 | 30 |
| Example 34 | A26 | 120 | B1 | 30 |
| Example 35 | A27 | 150 | B1 | 30 |
| Example 36 | A28 | 150 | B1 | 30 |
| Example 37 | A29 | 150 | B1 | 30 |
| Example 38 | A30 | 150 | B1 | 30 |

| | | Adhesion | Adhesion | Anti-blocking |
|---|---|---|---|---|
| | Haze | strength 1 | strength 2 | properties |
| Examples | (%) | (mN/cm) | (mN/cm) | (g/cm) |
| Example 1 | 0.9 | 16 | 6 | 2 |
| Example 2 | 0.9 | 22 | 9 | 2 |
| Example 3 | 0.9 | 13 | 6 | 2 |
| Example 4 | 1.0 | 14 | 4 | 2 |
| Example 5 | 0.9 | 30 | 10 | 2 |
| Example 6 | 0.9 | 11 | 3 | 2 |
| Example 7 | 0.9 | 38 | 8 | 2 |
| Example 8 | 0.9 | 29 | 6 | 2 |
| Example 9 | 1.0 | 17 | 6 | 2 |
| Example 10 | 1.0 | 34 | 8 | 2 |
| Example 11 | 0.9 | 19 | 6 | 2 |
| Example 12 | 0.9 | 45 | 11 | 3 |
| Example 13 | 1.0 | 17 | 5 | 2 |
| Example 14 | 1.1 | 32 | 5 | 2 |
| Example 15 | 0.9 | 43 | 10 | 3 |
| Example 16 | 0.8 | 17 | 8 | 2 |
| Example 17 | 0.8 | 43 | 10 | 3 |
| Example 18 | 0.9 | 31 | 7 | 2 |
| Example 19 | 1.3 | 17 | 7 | 2 |
| Example 20 | 1.1 | 35 | 15 | 2 |
| Example 21 | 0.8 | 12 | 9 | 2 |
| Example 22 | 0.8 | 23 | 12 | 2 |
| Example 23 | 0.8 | 50 | 20 | 3 |
| Example 24 | 0.9 | 19 | 10 | 2 |
| Example 25 | 0.8 | 14 | 9 | 2 |
| Example 26 | 0.8 | 20 | 11 | 2 |
| Example 27 | 0.9 | 26 | 21 | 2 |
| Example 28 | 1.0 | 21 | 10 | 2 |
| Example 29 | 0.9 | 21 | 12 | 2 |
| Example 30 | 0.8 | 23 | 18 | 2 |
| Example 31 | 1.0 | 21 | 10 | 2 |
| Example 32 | 1.1 | 27 | 13 | 2 |
| Example 33 | 0.8 | 19 | 15 | 2 |
| Example 34 | 0.8 | 26 | 10 | 2 |
| Example 35 | 1.2 | 32 | 20 | 2 |
| Example 36 | 0.9 | 20 | 10 | 2 |
| Example 37 | 0.9 | 22 | 8 | 2 |
| Example 38 | 0.9 | 30 | 10 | 2 |

| | Adhesiveness to | | Transfer properties |
|---|---|---|---|
| Examples | base material film | Transparency | to adherend |
| Example 1 | A | A | A |
| Example 2 | A | A | A |
| Example 3 | A | A | A |
| Example 4 | A | A | A |
| Example 5 | A | A | B |
| Example 6 | A | A | A |
| Example 7 | A | A | B |
| Example 8 | A | A | A |
| Example 9 | A | A | A |
| Example 10 | A | A | A |
| Example 11 | A | A | A |
| Example 12 | A | A | D |
| Example 13 | A | A | C |
| Example 14 | A | A | B |
| Example 15 | A | A | C |
| Example 16 | A | A | B |
| Example 17 | A | A | C |
| Example 18 | A | A | B |
| Example 19 | A | A | A |
| Example 20 | A | A | D |
| Example 21 | A | A | A |
| Example 22 | A | A | A |
| Example 23 | A | A | B |
| Example 24 | A | A | A |
| Example 25 | A | A | A |
| Example 26 | A | A | A |
| Example 27 | A | A | E |
| Example 28 | A | A | E |
| Example 29 | A | A | A |
| Example 30 | A | A | A |
| Example 31 | A | A | A |
| Example 32 | A | A | A |
| Example 33 | A | A | A |
| Example 34 | A | A | A |
| Example 35 | A | A | D |
| Example 36 | A | A | A |
| Example 37 | A | A | B |
| Example 38 | A | A | C |

TABLE 4

| | |
|---|---|
| Adhesive layer | Functional layer |

| | Coating | Thickness | Coating | Thickness |
|---|---|---|---|---|
| Examples | solution | (nm) | solution | (nm) |
| Example 39 | A1 | 150 | B2 | 30 |
| Example 40 | A2 | 120 | B2 | 30 |
| Example 41 | A4 | 120 | B2 | 30 |
| Example 42 | A5 | 150 | B2 | 30 |
| Example 43 | A16 | 150 | B2 | 30 |
| Example 44 | A18 | 150 | B2 | 30 |
| Example 45 | A19 | 200 | B2 | 30 |
| Example 46 | A20 | 150 | B2 | 30 |
| Example 47 | A25 | 150 | B2 | 30 |
| Example 48 | A1 | 150 | B3 | 30 |
| Example 49 | A2 | 120 | B3 | 30 |
| Example 50 | A4 | 120 | B3 | 30 |
| Example 51 | A5 | 150 | B3 | 30 |
| Example 52 | A16 | 150 | B3 | 30 |
| Example 53 | A18 | 150 | B3 | 30 |
| Example 54 | A19 | 200 | B3 | 30 |
| Example 55 | A20 | 150 | B3 | 30 |
| Example 56 | A25 | 150 | B3 | 30 |
| Example 57 | A1 | 150 | B4 | 30 |
| Example 58 | A2 | 120 | B4 | 30 |
| Example 59 | A4 | 120 | B4 | 30 |
| Example 60 | A5 | 150 | B4 | 30 |
| Example 61 | A16 | 150 | B4 | 30 |
| Example 62 | A18 | 150 | B4 | 30 |
| Example 63 | A19 | 200 | B4 | 30 |
| Example 64 | A20 | 150 | B4 | 30 |
| Example 65 | A25 | 150 | B4 | 30 |
| Example 66 | A1 | 150 | B5 | 30 |
| Example 67 | A2 | 120 | B5 | 30 |
| Example 68 | A4 | 120 | B5 | 30 |
| Example 69 | A5 | 150 | B5 | 30 |
| Example 70 | A16 | 150 | B5 | 30 |
| Example 71 | A18 | 150 | B5 | 30 |
| Example 72 | A19 | 200 | B5 | 30 |
| Example 73 | A20 | 150 | B5 | 30 |
| Example 74 | A25 | 150 | B5 | 30 |

| | | Adhesion | Adhesion | Anti-blocking |
|---|---|---|---|---|
| | Haze | strength 1 | strength 2 | properties |
| Examples | (%) | (mN/cm) | (mN/cm) | (g/cm) |
| Example 39 | 0.9 | 22 | 9 | 2 |
| Example 40 | 1.0 | 14 | 4 | 2 |
| Example 41 | 0.9 | 11 | 3 | 2 |
| Example 42 | 0.9 | 38 | 8 | 2 |
| Example 43 | 1.3 | 17 | 7 | 2 |
| Example 44 | 0.8 | 12 | 9 | 2 |
| Example 45 | 0.9 | 19 | 10 | 2 |
| Example 46 | 0.8 | 20 | 11 | 2 |
| Example 47 | 1.0 | 21 | 10 | 2 |
| Example 48 | 0.9 | 22 | 9 | 2 |
| Example 49 | 1.0 | 14 | 4 | 2 |
| Example 50 | 0.9 | 11 | 3 | 2 |
| Example 51 | 0.9 | 38 | 8 | 2 |
| Example 52 | 1.3 | 17 | 7 | 2 |
| Example 53 | 0.8 | 12 | 9 | 2 |
| Example 54 | 0.9 | 19 | 10 | 2 |
| Example 55 | 0.8 | 20 | 11 | 2 |
| Example 56 | 1.0 | 21 | 10 | 2 |
| Example 57 | 0.9 | 22 | 9 | 2 |
| Example 58 | 1.0 | 14 | 4 | 2 |
| Example 59 | 0.9 | 11 | 3 | 2 |
| Example 60 | 0.9 | 38 | 8 | 2 |
| Example 61 | 1.3 | 17 | 7 | 2 |
| Example 62 | 0.8 | 12 | 9 | 2 |
| Example 63 | 0.9 | 19 | 10 | 2 |
| Example 64 | 0.8 | 20 | 11 | 2 |
| Example 65 | 1.0 | 21 | 10 | 2 |
| Example 66 | 0.9 | 22 | 9 | 2 |
| Example 67 | 1.0 | 14 | 4 | 2 |
| Example 68 | 0.9 | 11 | 3 | 2 |
| Example 69 | 0.9 | 38 | 8 | 2 |
| Example 70 | 1.3 | 17 | 7 | 2 |
| Example 71 | 0.8 | 12 | 9 | 2 |
| Example 72 | 0.9 | 19 | 10 | 2 |
| Example 73 | 0.8 | 20 | 11 | 2 |
| Example 74 | 1.0 | 21 | 10 | 2 |

| | Adhesiveness to | | Transfer properties |
|---|---|---|---|
| Examples | base material film | Transparency | to adherend |
| Example 39 | A | A | A |
| Example 40 | A | A | A |
| Example 41 | A | A | A |
| Example 42 | A | A | B |
| Example 43 | A | A | A |
| Example 44 | A | A | A |
| Example 45 | A | A | A |
| Example 46 | A | A | A |
| Example 47 | A | A | A |
| Example 48 | A | A | A |
| Example 49 | A | A | A |
| Example 50 | A | A | A |
| Example 51 | A | A | B |
| Example 52 | A | A | A |
| Example 53 | A | A | A |
| Example 54 | A | A | A |
| Example 55 | A | A | A |
| Example 56 | A | A | A |
| Example 57 | A | A | A |
| Example 58 | A | A | A |
| Example 59 | A | A | A |
| Example 60 | A | A | B |
| Example 61 | A | A | A |
| Example 62 | A | A | A |
| Example 63 | A | A | A |
| Example 64 | A | A | A |
| Example 65 | A | A | A |
| Example 66 | A | A | A |
| Example 67 | A | A | A |
| Example 68 | A | A | A |
| Example 69 | A | A | B |
| Example 70 | A | A | A |
| Example 71 | A | A | A |
| Example 72 | A | A | A |
| Example 73 | A | A | A |
| Example 74 | A | A | A |

TABLE 5

| | |
|---|---|
| Adhesive layer | Functional layer |

| | Coating | Thickness | Coating | Thickness |
|---|---|---|---|---|
| Examples | solution | (nm) | solution | (nm) |
| Example 75 | A1 | 150 | B6 | 50 |
| Example 76 | A2 | 120 | B6 | 50 |
| Example 77 | A4 | 120 | B6 | 50 |
| Example 78 | A5 | 150 | B6 | 50 |
| Example 79 | A16 | 150 | B6 | 50 |
| Example 80 | A18 | 150 | B6 | 50 |
| Example 81 | A19 | 200 | B6 | 50 |
| Example 82 | A20 | 150 | B6 | 50 |
| Example 83 | A25 | 150 | B6 | 50 |
| Example 84 | A1 | 150 | B7 | 30 |
| Example 85 | A2 | 120 | B7 | 30 |
| Example 86 | A4 | 120 | B7 | 30 |
| Example 87 | A5 | 150 | B7 | 30 |
| Example 88 | A16 | 150 | B7 | 30 |
| Example 89 | A18 | 150 | B7 | 30 |
| Example 90 | A19 | 200 | B7 | 30 |
| Example 91 | A20 | 150 | B7 | 30 |
| Example 92 | A25 | 150 | B7 | 30 |

| | | Adhesion | Adhesion | Anti-blocking |
|---|---|---|---|---|
| | Haze | strength 1 | strength 2 | properties |
| Examples | (%) | (mN/cm) | (mN/cm) | (g/cm) |
| Example 75 | 0.9 | 20 | 9 | 1 |
| Example 76 | 1.0 | 14 | 4 | 1 |
| Example 77 | 0.9 | 11 | 3 | 1 |
| Example 78 | 0.9 | 35 | 8 | 1 |
| Example 79 | 1.3 | 17 | 7 | 1 |
| Example 80 | 0.8 | 12 | 9 | 1 |
| Example 81 | 0.9 | 18 | 10 | 1 |
| Example 82 | 0.8 | 20 | 10 | 1 |
| Example 83 | 1.0 | 20 | 10 | 1 |
| Example 84 | 0.9 | 22 | 9 | 3 |
| Example 85 | 1.0 | 14 | 4 | 2 |
| Example 86 | 0.9 | 11 | 3 | 2 |
| Example 87 | 0.9 | 38 | 8 | 4 |
| Example 88 | 1.3 | 17 | 7 | 2 |
| Example 89 | 0.8 | 12 | 9 | 2 |
| Example 90 | 0.9 | 19 | 10 | 2 |
| Example 91 | 0.8 | 20 | 11 | 3 |
| Example 92 | 1.0 | 21 | 10 | 3 |

| | Adhesiveness to | | Transfer properties |
|---|---|---|---|
| Examples | base material film | Transparency | to adherend |
| Example 75 | A | A | A |
| Example 76 | A | A | A |
| Example 77 | A | A | A |
| Example 78 | A | A | B |
| Example 79 | A | A | A |
| Example 80 | A | A | A |
| Example 81 | A | A | A |
| Example 82 | A | A | A |
| Example 83 | A | A | A |
| Example 84 | A | A | A |
| Example 85 | A | A | A |
| Example 86 | A | A | A |
| Example 87 | A | A | B |
| Example 88 | A | A | A |
| Example 89 | A | A | A |
| Example 90 | A | A | A |
| Example 91 | A | A | A |
| Example 92 | A | A | A |

TABLE 6

| | |
|---|---|
| Adhesive layer | Functional layer |

| | Coating | Thickness | Coating | Thickness |
|---|---|---|---|---|
| Examples | solution | (nm) | solution | (nm) |
| Example 93 | A1 | 150 | B8 | 50 |
| Example 94 | A2 | 120 | B8 | 50 |
| Example 95 | A4 | 120 | B8 | 50 |
| Example 96 | A5 | 150 | B8 | 50 |
| Example 97 | A16 | 150 | B8 | 50 |
| Example 98 | A18 | 150 | B8 | 50 |
| Example 99 | A19 | 200 | B8 | 50 |
| Example 100 | A20 | 150 | B8 | 50 |
| Example 101 | A25 | 150 | B8 | 50 |
| Example 102 | A1 | 150 | B9 | 30 |
| Example 103 | A2 | 120 | B9 | 30 |
| Example 104 | A4 | 120 | B9 | 30 |
| Example 105 | A5 | 150 | B9 | 30 |
| Example 106 | A16 | 150 | B9 | 30 |
| Example 107 | A18 | 150 | B9 | 30 |
| Example 108 | A19 | 200 | B9 | 30 |
| Example 109 | A20 | 150 | B9 | 30 |
| Example 110 | A25 | 150 | B9 | 30 |
| Example 111 | A1 | 150 | B10 | 50 |
| Example 112 | A2 | 120 | B10 | 50 |
| Example 113 | A4 | 120 | B10 | 50 |
| Example 114 | A5 | 150 | B10 | 50 |
| Example 115 | A16 | 150 | B10 | 50 |
| Example 116 | A18 | 150 | B10 | 50 |
| Example 117 | A19 | 200 | B10 | 50 |
| Example 118 | A20 | 150 | B10 | 50 |
| Example 119 | A25 | 150 | B10 | 50 |

| | | Adhesion | Adhesion | Anti-blocking |
|---|---|---|---|---|
| | Haze | strength 1 | strength 2 | properties |
| Examples | (%) | (mN/cm) | (mN/cm) | (g/cm) |
| Example 93 | 0.9 | 20 | 9 | 1 |
| Example 94 | 1.0 | 14 | 4 | 1 |
| Example 95 | 0.9 | 11 | 3 | 1 |
| Example 96 | 0.9 | 35 | 8 | 1 |
| Example 97 | 1.3 | 17 | 7 | 1 |
| Example 98 | 0.8 | 12 | 9 | 1 |
| Example 99 | 0.9 | 18 | 10 | 1 |
| Example 100 | 0.8 | 20 | 10 | 1 |
| Example 101 | 1.0 | 20 | 10 | 1 |
| Example 102 | 0.9 | 22 | 9 | 2 |
| Example 103 | 1.0 | 14 | 4 | 2 |
| Example 104 | 0.9 | 11 | 3 | 2 |
| Example 105 | 0.9 | 38 | 8 | 2 |
| Example 106 | 1.3 | 17 | 7 | 2 |
| Example 107 | 0.8 | 12 | 9 | 2 |
| Example 108 | 0.9 | 19 | 10 | 2 |
| Example 109 | 0.8 | 20 | 11 | 2 |
| Example 110 | 1.0 | 21 | 10 | 2 |
| Example 111 | 0.9 | 22 | 9 | 2 |
| Example 112 | 1.0 | 14 | 4 | 2 |
| Example 113 | 0.9 | 11 | 3 | 2 |
| Example 114 | 0.9 | 38 | 8 | 2 |
| Example 115 | 1.3 | 17 | 7 | 2 |
| Example 116 | 0.8 | 12 | 9 | 2 |
| Example 117 | 0.9 | 19 | 10 | 2 |
| Example 118 | 0.8 | 20 | 11 | 2 |
| Example 119 | 1.0 | 21 | 10 | 2 |

| | Adhesiveness to | | Transfer properties |
|---|---|---|---|
| Examples | base material film | Transparency | to adherend |
| Example 93 | A | A | A |
| Example 94 | A | A | A |
| Example 95 | A | A | A |
| Example 96 | A | A | B |
| Example 97 | A | A | A |
| Example 98 | A | A | A |
| Example 99 | A | A | A |
| Example 100 | A | A | A |
| Example 101 | A | A | A |
| Example 102 | A | A | A |
| Example 103 | A | A | A |
| Example 104 | A | A | A |
| Example 105 | A | A | B |
| Example 106 | A | A | A |
| Example 107 | A | A | A |
| Example 108 | A | A | A |
| Example 109 | A | A | A |
| Example 110 | A | A | A |
| Example 111 | A | A | A |
| Example 112 | A | A | A |
| Example 113 | A | A | A |
| Example 114 | A | A | B |
| Example 115 | A | A | A |
| Example 116 | A | A | A |
| Example 117 | A | A | A |
| Example 118 | A | A | A |
| Example 119 | A | A | A |

TABLE 7

| Examples | Surface resistance (Ω) | Deposition of dirt and dusts |
|---|---|---|
| Example 93 | 2 × 10⁹ | A |
| Example 94 | 2 × 10⁹ | A |
| Example 95 | 2 × 10⁹ | A |
| Example 96 | 2 × 10⁹ | A |
| Example 97 | 2 × 10⁹ | A |
| Example 98 | 2 × 10⁹ | A |
| Example 99 | 2 × 10⁹ | A |
| Example 100 | 2 × 10⁹ | A |
| Example 101 | 2 × 10⁹ | A |
| Example 102 | 1 × 10¹⁰ | A |
| Example 103 | 1 × 10¹⁰ | A |
| Example 104 | 1 × 10¹⁰ | A |
| Example 105 | 1 × 10¹⁰ | A |
| Example 106 | 1 × 10¹⁰ | A |
| Example 107 | 1 × 10¹⁰ | A |
| Example 108 | 1 × 10¹⁰ | A |
| Example 109 | 1 × 10¹⁰ | A |
| Example 110 | 1 × 10¹⁰ | A |
| Example 111 | 1 × 10¹⁰ | A |
| Example 112 | 1 × 10¹⁰ | A |
| Example 113 | 1 × 10¹⁰ | A |
| Example 114 | 1 × 10¹⁰ | A |
| Example 115 | 1 × 10¹⁰ | A |
| Example 116 | 1 × 10¹⁰ | A |
| Example 117 | 1 × 10¹⁰ | A |
| Example 118 | 1 × 10¹⁰ | A |
| Example 119 | 1 × 10¹⁰ | A |

TABLE 8

| | |
|---|---|
| Adhesive layer | Functional layer |

| | Coating | Thickness | Coating | Thickness |
|---|---|---|---|---|
| Examples | solution | (nm) | solution | (nm) |
| Example 120 | A1 | 150 | — | — |
| Example 121 | A2 | 120 | — | — |
| Example 122 | A4 | 120 | — | — |
| Example 123 | A5 | 150 | — | — |
| Example 124 | A16 | 150 | — | — |
| Example 125 | A18 | 150 | — | — |
| Example 126 | A19 | 200 | — | — |
| Example 127 | A20 | 150 | — | — |
| Example 128 | A25 | 150 | — | — |
| Example 129 | A1 | 150 | C6 | 30 |
| Example 130 | A1 | 150 | B1 | 30 |
| Example 131 | A1 | 150 | — | — |
| Example 132 | A1 | 150 | B1 | 30 |
| Example 133 | A1 | 150 | — | — |
| Example 134 | A1 | 150 | B1 | 30 |
| Example 135 | A1 | 150 | — | — |
| Example 136 | A1 | 150 | — | — |
| Example 137 | A9 | 150 | B1 | 30 |
| Example 138 | A9 | 20000 | — | — |

| | | Adhesion | Adhesion | Anti-blocking |
|---|---|---|---|---|
| | Haze | strength 1 | strength 2 | properties |
| Examples | (%) | (mN/cm) | (mN/cm) | (g/cm) |
| Example 120 | 0.9 | 22 | 9 | 16 |
| Example 121 | 1.0 | 14 | 4 | 10 |
| Example 122 | 0.9 | 11 | 3 | 8 |
| Example 123 | 0.9 | 38 | 8 | 24 |
| Example 124 | 1.3 | 17 | 7 | 12 |
| Example 125 | 0.8 | 12 | 9 | 9 |
| Example 126 | 0.9 | 19 | 10 | 10 |
| Example 127 | 0.8 | 20 | 11 | 14 |
| Example 128 | 1.0 | 21 | 10 | 18 |
| Example 129 | 0.9 | 22 | 9 | 19 |
| Example 130 | 1.8 | 20 | 9 | 2 |
| Example 131 | 1.7 | 20 | 9 | 12 |
| Example 132 | 1.8 | 22 | 9 | 2 |
| Example 133 | 1.7 | 22 | 9 | 8 |
| Example 134 | 2.7 | 22 | 9 | 2 |
| Example 135 | 2.6 | 22 | 9 | 6 |
| Example 136 | 4.0 | 22 | 9 | 6 |
| Example 137 | 1.1 | 50 | 15 | 5 |
| Example 138 | — | — | — | — |

| | Adhesiveness to | | Transfer properties |
|---|---|---|---|
| Examples | base material film | Transparency | to adherend |
| Example 120 | A | A | A |
| Example 121 | A | A | A |
| Example 122 | A | A | A |
| Example 123 | A | A | B |
| Example 124 | A | A | A |
| Example 125 | A | A | A |
| Example 126 | A | A | A |
| Example 127 | A | A | A |
| Example 128 | A | A | A |
| Example 129 | A | A | A |
| Example 130 | A | A | A |
| Example 131 | A | A | A |
| Example 132 | A | A | A |
| Example 133 | A | A | A |
| Example 134 | A | B | A |
| Example 135 | A | B | A |
| Example 136 | A | C | A |
| Example 137 | B | A | E |
| Example 138 | B | — | E |

TABLE 9

| | |
|---|---|
| Adhesive layer | Functional layer |

| Comparative | Coating | Thickness | Coating | Thickness |
|---|---|---|---|---|
| Examples | solution | (nm) | solution | (nm) |
| Comparative | — | — | — | — |
| Example 1 | | | | |
| Comparative | C1 | 150 | B1 | 30 |
| Example 2 | | | | |
| Comparative | C2 | 150 | B1 | 30 |
| Example 3 | | | | |
| Comparative | C3 | 150 | B1 | 30 |
| Example 4 | | | | |
| Comparative | C4 | 150 | B1 | 30 |
| Example 5 | | | | |
| Comparative | C5 | 150 | B1 | 30 |
| Example 6 | | | | |

| | | Adhesion | Adhesion | Anti-blocking |
|---|---|---|---|---|
| Comparative | Haze | strength 1 | strength 2 | properties |
| Examples | (%) | (mN/cm) | (mN/cm) | (g/cm) |
| Comparative | 0.6 | 0 | 0 | — |
| Example 1 | | | | |
| Comparative | 0.8 | 0 | 0 | 1 |
| Example 2 | | | | |
| Comparative | 0.8 | 0 | 0 | 1 |
| Example 3 | | | | |
| Comparative | 0.9 | 0 | 0 | 1 |
| Example 4 | | | | |
| Comparative | 0.8 | 0 | 0 | 1 |
| Example 5 | | | | |
| Comparative | 0.8 | 0 | 0 | 1 |
| Example 6 | | | | |

| Comparative | Adhesiveness to | | Transfer properties |
|---|---|---|---|
| Examples | base material film | Transparency | to adherend |
| Comparative | — | — | — |
| Example 1 | | | |
| Comparative | — | — | — |
| Example 2 | | | |
| Comparative | — | — | — |
| Example 3 | | | |
| Comparative | — | — | — |
| Example 4 | | | |
| Comparative | — | — | — |
| Example 5 | | | |
| Comparative | — | — | — |
| Example 6 | | | |

### INDUSTRIAL APPLICABILITY

The adhesive film according to the present invention can be suitably used, for example, in the applications such as a surface protective film used for preventing formation of scratches or deposition of contaminants upon transportation, storage or processing of resin plates, metal plates, etc., in which the film is required to have less fisheyes, excellent mechanical strength and heat resistance, and good adhesion properties.

1. A process for producing an adhesive film, comprising the steps of:
providing a coating layer on at least one surface of a polyester film, the coating layer comprising a (meth)acrylic resin comprising a (meth)acrylate unit that comprises an alkyl group having not less than 4 carbon atoms at an ester end thereof, a content of the (meth)acrylate unit in the (meth)acrylic resin being not less than 20% by weight; and
drawing the polyester film provided with the coating layer in at least one direction thereof.

2. The process for producing an adhesive film according to claim 1, wherein the adhesive layer has a thickness of not more than 10 μm.

3. The process for producing an adhesive film according to claim 1, wherein the (meth)acrylic resin has a glass transition point of not higher than 0° C.

4. The process for producing an adhesive film according to claim 1, wherein the (meth)acrylic resin is a compound having not more than 2 carbon atoms at an ester end thereof or a compound having a ring structure.

5. The process for producing an adhesive film according to claim 1, wherein a content of a constitutional unit derived from the compound having not more than 2 carbon atoms at an ester end thereof in the (meth)acrylic resin is not more than 50% by weight.

6. The process for producing an adhesive film according to claim 1, wherein a content of a constitutional unit derived from the compound having a ring structure in the (meth)acrylic resin is not more than 50% by weight.

7. The process for producing an adhesive film according to claim 1, wherein the adhesive layer comprises a crosslinking agent.

8. The process for producing an adhesive film according to claim 1, wherein a content of the crosslinking agent in the adhesive layer is not more than 60% by weight.

9. The process for producing an adhesive film according to claim 1, wherein an arithmetic average roughness (Sa) of a surface of the adhesive layer is not more than 50 nm.

10. The process for producing an adhesive film according to claim 1, wherein the adhesive film further comprises a functional layer formed on a surface of the polyester film which is opposite to the surface provided with the adhesive layer.

11. The process for producing an adhesive film according to claim 1, wherein a haze of the adhesive film is not more than 5.0%.
